(19) United States
(12) Patent Application Publication
(10) Pub. No.: US 2017/0144892 A1
(43) Pub. Date: May 25, 2017

(54) Processing Scheme and System for Gray Water Purification

(71) Applicant: Concurrent Technologies Corporation, Johnstown, PA (US)

(72) Inventors: Michel J. McCluskey, Somerset, PA (US); Paul John Brezovec, Johnstown, PA (US); Thomas J. Piro, Johnstown, PA (US)

(21) Appl. No.: 15/358,699

(22) Filed: Nov. 22, 2016

Related U.S. Application Data
(60) Provisional application No. 62/259,793, filed on Nov. 25, 2015.

(51) Int. Cl. C02F 1/00; C02F 1/32; C02F 1/72; C02F 1/44

(52) U.S. Cl. CPC C02F 1/008; C02F 1/444; C02F 1/004; C02F 1/44; C02F 1/442; C02F 1/32; C02F 1/72; C02F 2303/04; C02F 2303/16; C02F 2301/046; C02F 2103/002

(57) ABSTRACT

Processing methods and systems are directed toward water filtration and/or purification techniques and/or energy recovery processes that may be used to generate usable water. Some embodiments can include at least one filtration and/or purification stage that processes water to a level of purity. Some embodiments can include recirculating water streams through a stage or another stage to achieve a desired level of purity. Some embodiments can include use of an energy recovery unit that may harvest energy from the water stream of the system and supply the harvested energy therefrom back into the system.

### CROSS-REFERENCE TO RELATED APPLICATIONS

This application claims the benefit of U.S. Provisional Patent Application No. 62/259,793 titled “Processing Scheme and System for Gray Water Purification” filed Nov. 25, 2015, the entire contents of which is incorporated herein by reference.

### STATEMENT REGARDING FEDERALLY SPONSORED RESEARCH/DEVELOPMENT

The present invention was made with government support under Contract No. FA8650-09-D-5601/012D, awarded by the Air Force Research Laboratory. The Government has certain rights in the invention.

### FIELD OF THE INVENTION

The present invention is related to methods and systems directed toward water purification and/or filtration, which may include at least one processing stage. Some embodiments can include at least one energy recovery process.

### BACKGROUND OF THE INVENTION

The need for purified water is one of the world's enduring problems. Yet, water acquisition and disposal can be a major logistical burden. The burden can be exacerbated while conducting such operations in remote areas that are removed from adequate infrastructure for filtering, processing, and disposal of the water. For example, setting up forward operating bases during military or humanitarian aid operations or providing usable water to populated areas devoid of infrastructure related to energy and water management facilities typically require a means to generate usable water without relying on large energy supplies and/or producing large amounts of wastewater. Many of these operations must be carried out with limited resources (including human capital), thus water processing in such situations may further benefit from low maintenance water filtration systems.

The present invention is directed toward overcoming one or more of the above-identified problems.

### SUMMARY OF THE INVENTION

Embodiments of the water processing system and water processing method can be directed toward a water filtration and/or purification process, which may be used to generate usable or reusable water. For example, an embodiment of the system may be used to generate potable and/or non-potable water from a waste water source. As another example, an embodiment of the system may be used to generate potable and/or non-potable water from water having increased salinity (e.g., brackish, saline, etc.). Some embodiments can include at least one processing stage through which waste water can be processed. Each stage can process the water to a certain purity level. A purity level for one stage may differ from a purity level of another stage. A water stream within the system can be caused to flow through each stage or by-pass a stage. Some embodiments can cause the water stream to be recirculated through any of the stages that had already processed the water stream.

In some embodiments, the water processing system and/or method can include at least one energy recovery process. The energy recovery process can include a flow battery system, a pressure exchanger system, an eductor unit, etc. Some embodiments can be configured so that the system operates on little to no energy being supplied from an outside energy source (e.g., a source that is external to the system).

In an exemplary embodiment, a water processing unit can include at least one stage comprising a pre-filtration unit, an ultra-filtration unit, an osmosis unit, and/or a disinfection unit. The at least one stage can be configured to process waste water having a first concentration of particulate matter and/or particulate matter of a first size into a water stream having a second concentration of the particulate matter and/or particulate matter of a second size. The second concentration of the particulate matter can be less than the first concentration of the particulate matter. The particulate matter second size can be less than the particulate matter first size. The unit can further include at least one controller configured to analyze the second concentration of the particulate matter and/or the particulate matter second size and compare it to a predetermined particulate matter concentration and/or a predetermined particulate matter size. When the second concentration of the particulate matter and/or the particulate matter second size is greater than the predetermined particulate matter concentration and/or the predetermined particulate matter size the controller can cause the water stream to be recirculated through the at least one stage.

In some embodiments, the water stream exiting the water processing unit is usable water, the usable water having the predetermined particulate matter concentration and/or the predetermined particulate matter size. In some embodiments, the at least one stage can include a first stage and a second stage. The first stage can be a pre-filtration stage. The second stage can be an osmosis stage. In some embodiments, the at least one stage can include a first stage, a second stage, and a third stage. The first stage can be a pre-filtration stage. The second stage can be an ultra-filtration stage. The third stage can be an osmosis stage. In some embodiments, the at least one stage can include a first stage, a second stage, a third stage, and a fourth stage. The first stage can be a pre-filtration stage. The second stage can be an ultra-filtration stage. The third stage can be an osmosis stage. The fourth stage can be a disinfection stage.

In some embodiments, the waste water can be within a temperature range from 34 degrees Fahrenheit (° F.) to 150° F. The at least one stage can include at least one of a filter and a membrane, each configured to operate with the water stream being within the temperature range from 34° F. to 150° F. In some embodiments, the water stream exiting the water processing unit can be usable water, the usable water being within the temperature range from 34° F. to 150° F. In some embodiments, the at least one stage can be configured to operate within a differential pressure range from 50 to 70 pounds per square inch (psi).

In some embodiments, the unit can further include a plurality of stages. A first stage can be configured to receive the water stream from a second stage to facilitate backwashing operations.

In some embodiments, the at least one stage can be configured to operate within a differential pressure range from 120 to 250 psi.

In some embodiments the unit further includes a plurality of stages, at least one stage being an osmosis stage and retentate from the osmosis stage is used for backwashing another stage.

In some embodiments, the pre-filtration stage can include at least one mechanical filter. The ultra-filtration stage can include at least one of a micro-filter membrane, an ultra-filter membrane, and a nano-filter membrane. The osmosis stage can include at least one osmosis semipermeable membrane. The disinfection stage can include an application of an oxidizer agent and/or ultraviolet radiation.

In some embodiments, the unit can include a plurality of stages wherein each stage may be configured to process the water stream to a purity level. In some embodiments, the purity level of one stage can differ from the purity level of another stage. In some embodiments, the first stage can process the water stream to a first purity level. The second stage can process the water stream to a second purity level. The third stage can process the water stream to a third purity level. The fourth stage can process the water stream to a fourth purity level. The fourth purity level can be greater than the third purity level. The third purity level can be greater than the second purity level. The second purity level can be greater than the first purity level.

In some embodiments, the unit can include at least one energy recovery unit that may be configured to harvest energy from the water stream. In some embodiments, the at least one energy recovery unit can include a battery unit, an eductor unit, and/or a pressure exchanger.

In another exemplary embodiment, a water processing system can include a waste water generation source to generate waste water. The system can include at least one first pump to direct the waste water into a water processing unit. The water processing unit can include at least one stage comprising a pre-filtration unit, an ultra-filtration unit, an osmosis unit, and/or a disinfection unit. The at least one stage can be configured to process the waste water having a first concentration of particulate matter and/or particulate matter of a first size into a water stream having a second concentration of the particulate matter and/or particulate matter of a second size. The second concentration of the particulate matter can be less than the first concentration of the particulate matter and the particulate matter second size can be less than the particulate matter first size. At least one controller can be configured to analyze the second concentration of the particulate matter and/or the particulate matter second size and compare it to a predetermined particulate matter concentration and/or a predetermined particulate matter size. When the second concentration of the particulate matter and/or the particulate matter second size is greater than the predetermined particulate matter concentration and/or the predetermined particulate matter size the controller can cause the water stream to be recirculated through the at least one stage. The water stream exiting the water processing unit can be usable water, the usable water having the predetermined particulate matter concentration and/or the predetermined particulate matter size. At least one second pump can be used to direct the usable water to the waste water generation source and/or outside of the water processing system.

In another exemplary embodiment, a method for processing water can include receiving waste water from a waste water source into a water processing unit comprising at least one stage comprising a pre-filtration unit, an ultra-filtration unit, an osmosis unit, and/or a disinfection unit. The method can further include processing the waste water having a first concentration of particulate matter and/or particulate matter of a first size into a water stream having a second concentration of the particulate matter and/or particulate matter of a second size. The second concentration of the particulate matter can be less than the first concentration of the particulate matter and the particulate matter second size can be less than the particulate matter first size. The method can further include analyze the second concentration of the particulate matter and/or the particulate matter second size by a controller and comparing it to a predetermined particulate matter concentration and/or a predetermined particulate matter size. The method can further include recirculating the water stream through the at least one stage when the second concentration of the particulate matter and/or the particulate matter second size is greater than the predetermined particulate matter concentration and/or the predetermined particulate matter size.

In some embodiments of the method, the waste water can be within a temperature range from 34° F. to 150° F. The water stream exiting the water processing unit can be usable water, the usable water being within the temperature range from 34° F. to 150° F.

While these potential advantages are made possible by technical solutions offered herein, they are not required to be achieved. The presently disclosed method and system can be implemented to achieve technical advantages, whether or not these potential advantages, individually or in combination, are sought or achieved.

Further features, aspects, objects, advantages, and possible applications of the present invention will become apparent from a study of the exemplary embodiments and examples described below, in combination with the Figures.

### BRIEF DESCRIPTION OF THE DRAWINGS

The above and other objects, aspects, features, advantages and possible applications of the present invention will be more apparent from the following more particular description thereof, presented in conjunction with the following drawings, in which:

FIG. 1A shows an exemplary block diagram of an embodiment of a water processing system, FIG. 1B shows an exemplary block diagram of an embodiment of a water processing system with an energy recovery unit, and FIG. 1C shows an exemplary block diagram of an embodiment of a water processing system with a controller that may be in connection with a computer device and/or a computer system.

FIGS. 2A-2B show block diagrams of an exemplary three-stage water filtration/purification unit structured to operate in an exemplary straight-series run configuration, and an exemplary three-stage water filtration/purification unit structured to operate in an exemplary recircular-series run configuration, respectively.

FIGS. 3A-3B show block diagrams of an exemplary four-stage water filtration/purification unit structured to operate in an exemplary straight-series run configuration, and an exemplary four-stage water filtration/purification unit structured to operate in an exemplary recircular-series run configuration, respectively.

FIG. 4 shows an exemplary decision flow diagram that may be used to generate a recirculation loop for a water stream between two stages.

FIG. 5A shows an exemplary block diagram of an embodiment of the water processing system with a four-stage water filtration/purification unit. FIGS. 5B-5C show an exemplary schematic that may be used to represent an embodiment of the water processing system. Note, that FIG. 5C is a continuation of FIG. 5B.

FIG. 6A shows an exemplary block diagram of an embodiment of the water processing system that includes a battery as an energy recovery unit.

FIG. 6B shows an exemplary block diagram of an embodiment of the water processing system that includes a pressure exchanger as an energy recovery unit.

FIG. 6C shows an exemplary block diagram of an embodiment of the water processing system that includes an educator as an energy recovery unit.

FIGS. 7A-7B show exemplary schematics that may be used to represent embodiments of a pre-filtration stage configured for mechanical filtration.

FIG. 8A shows an exemplary schematic that may be used to represent an embodiment of an ultra-filtration stage configured for ultra-filtration.

FIG. 8B shows an exemplary schematic that may be used to represent an embodiment of an ultra-filtration stage configured for nano-filtration.

FIG. 9 shows an exemplary schematic that may be used to represent an embodiment of an osmosis stage.

FIG. 10 shows an exemplary schematic that may be used to represent an embodiment of a disinfection stage.

FIG. 11 shows an exemplary configuration of an embodiment of the water processing system within a housing structure.

FIG. 12 shows an exemplary user interface that may be displayed via a computer device that may be used with an embodiment of the water processing system.

FIG. 13 shows an exemplary block diagram of another embodiment of the water processing system.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

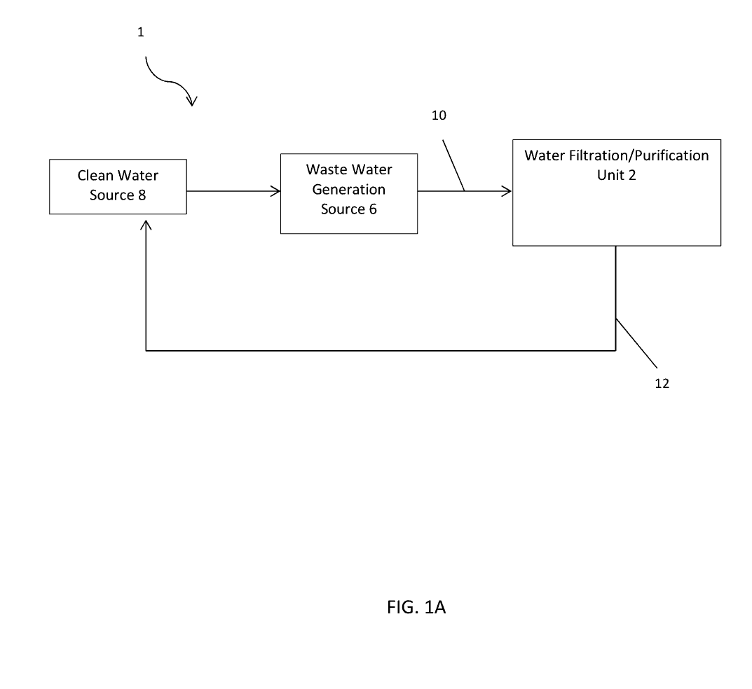

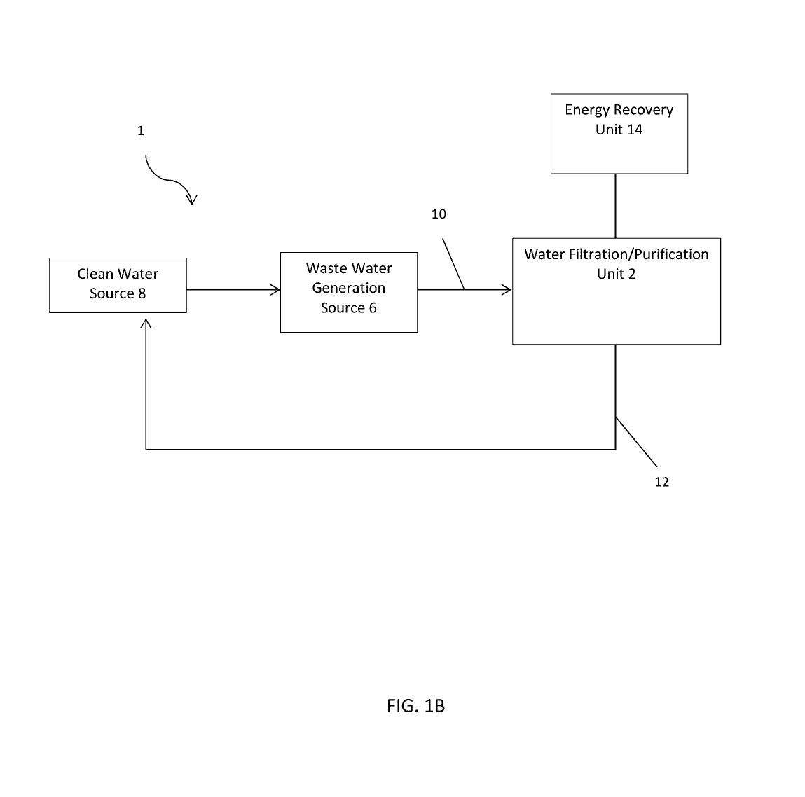

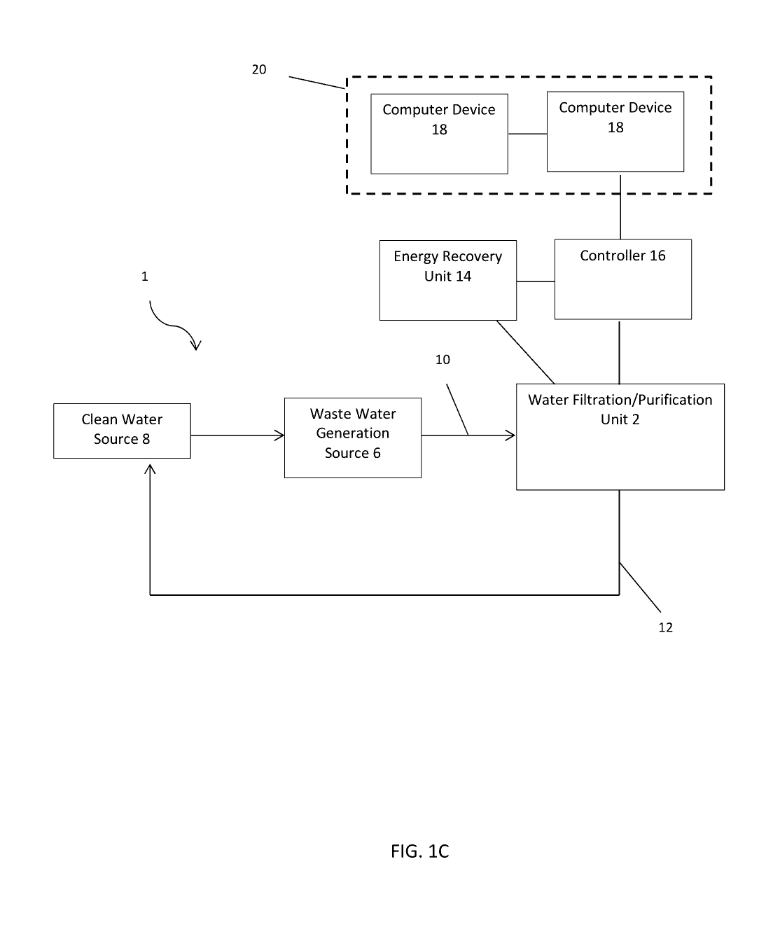

Referring to FIGS. 1A-1C, an embodiment of the water processing system 1 can include at least one water filtration/purification unit 2. The water filtration/purification unit 2 can include at least one stage 4 for filtering and/or purifying water. This may include generating purified water and/or reusable water. The water processing system 1 may include a waste water generation source 6. The water processing system 1 may also include a clean water source 8. For example, the water processing system 1 can be configured to take in waste water 10 from the waste water generation source 6 and direct clean water and/or usable water 12 to the clean water source 8. (see FIG. 1A). In some embodiments, the water processing system 1 can include at least one energy recovery unit 14. (see FIG. 1B) The water processing system 1 can include at least one controller 16. (see FIG. 1C). The controller 16 can be a processor having a non-volatile memory, where the memory includes programmable language stored thereon to instruct the processor to carry out logical functions. The controller 16 can be a programmable logic controller, for example. In at least one embodiment, the controller 16 can be in connection with a computer device 18 and/or a computer system 20.

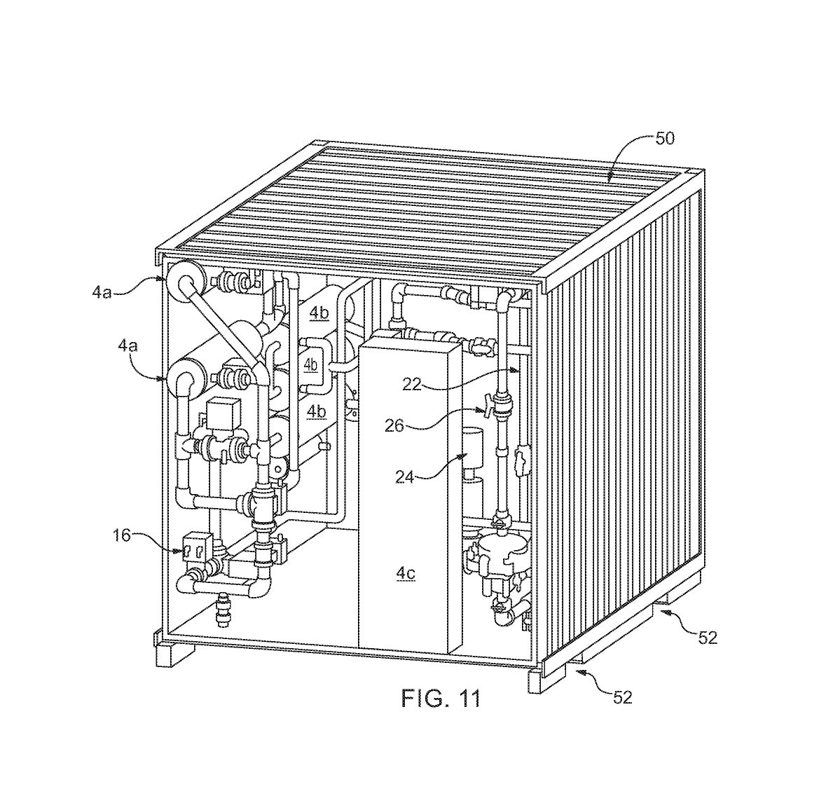

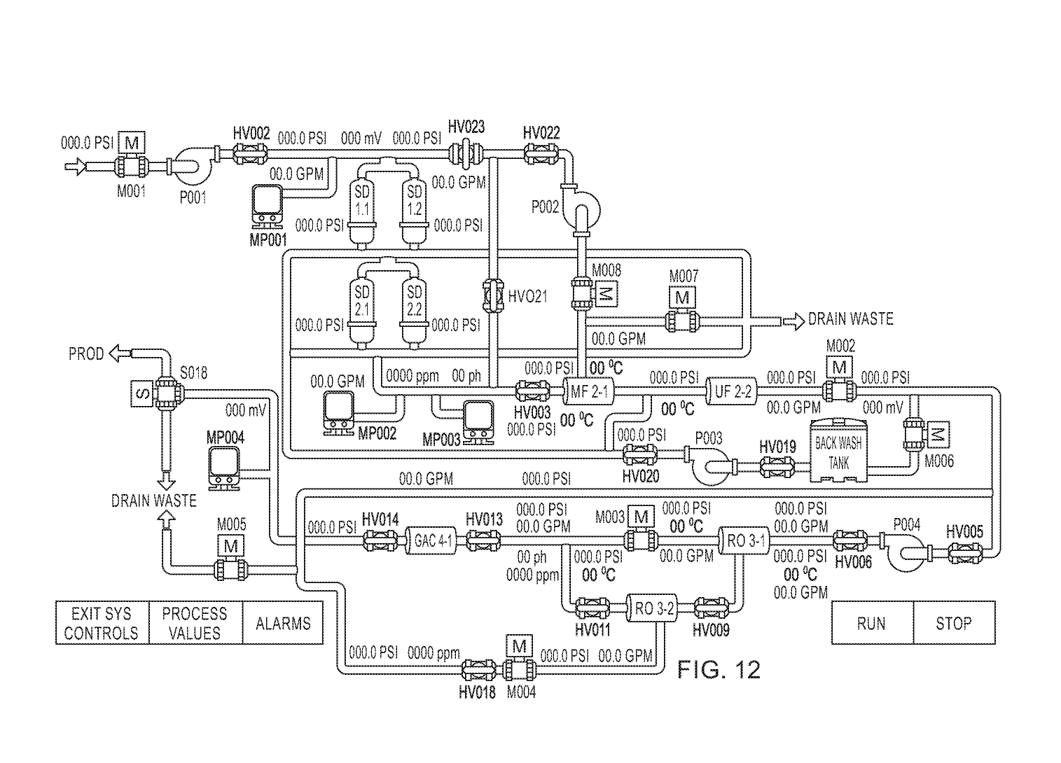

The various embodiments of the water processing system 1 can include any number of pipes 22, pumps 24, valves 26, tanks 28, and other components, such as sensors, meters, couplings, etc. that may be used to effectively contain and transfer water flowing through the system 1. (See FIG. 11). Placement, connection, and use of such components are known in the art, and thus a detailed description of them is not necessary. The controller 16 can be in connection with any of the components to control the operation thereof. For example, a controller 16 can be in connection with a pressure sensor or water flow sensor in a pipe 22, and depending on the pressure the controller 16 can cause a pump 24 to turn on or turn off, for example, so as to change the pressure or water flow (see FIGS. 11-12). In some embodiments, the controller 16 can be used to control characteristics and specific functions of any stage 4 of the system 1 by causing certain components to perform in a specified way. For example, the controller 16 can cause components to increase or decrease water pressure differentials on a certain stage 4 to improve the efficiency of the filtration of that stage. As another example, the controller 16 can be used to cause components to change water flow direction to generate a backwash. This may be done to clean a filter or a membrane of a stage 4.

The water processing systems 1 shown in FIGS. 1A-1C are exemplary, and it should be understood that other configurations can be used. For example, there can be more than one water filtration/purification unit 2, energy recovery unit 14, and/or controller 16. Further, placement of the filtration/purification unit 2, energy recovery unit 14, and/or controller 16 can be at different locations to achieve a specific result and/or to implement any of the embodiments disclosed herein.

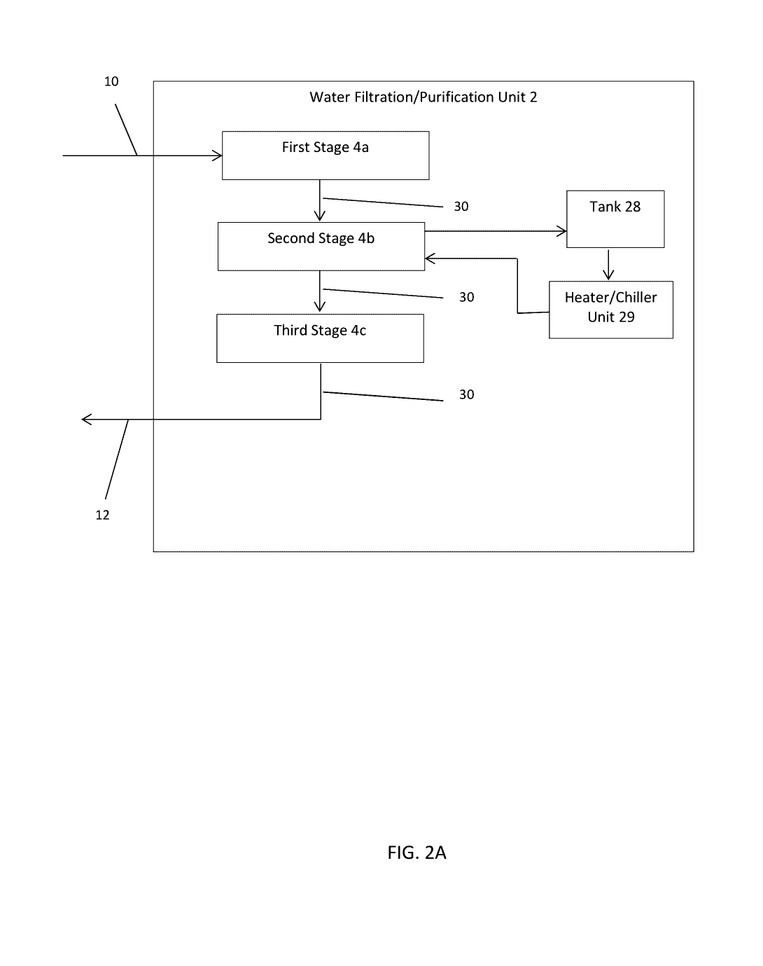

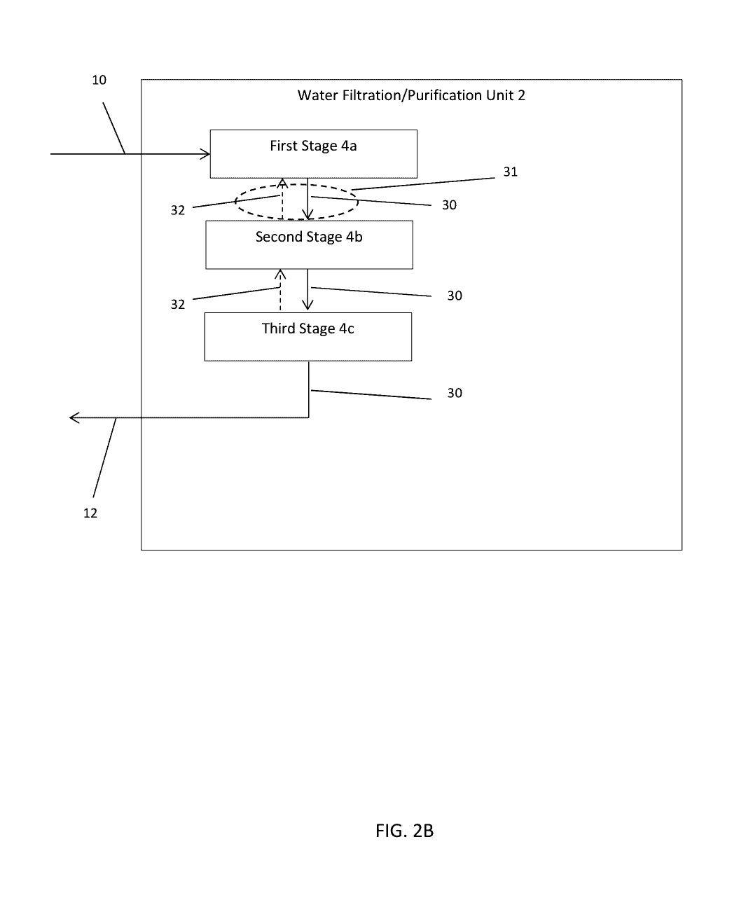

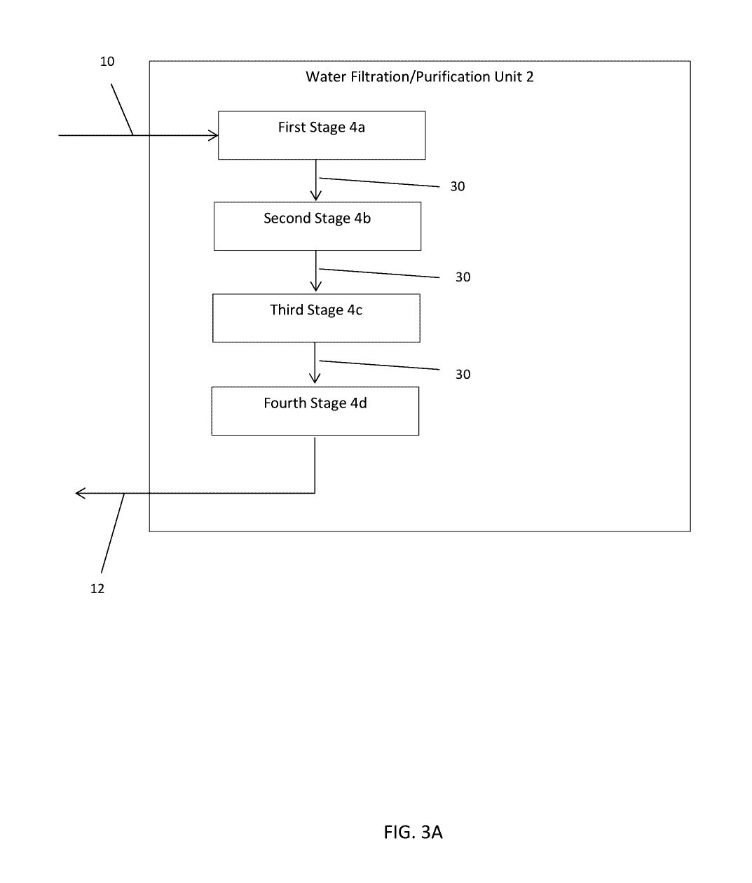

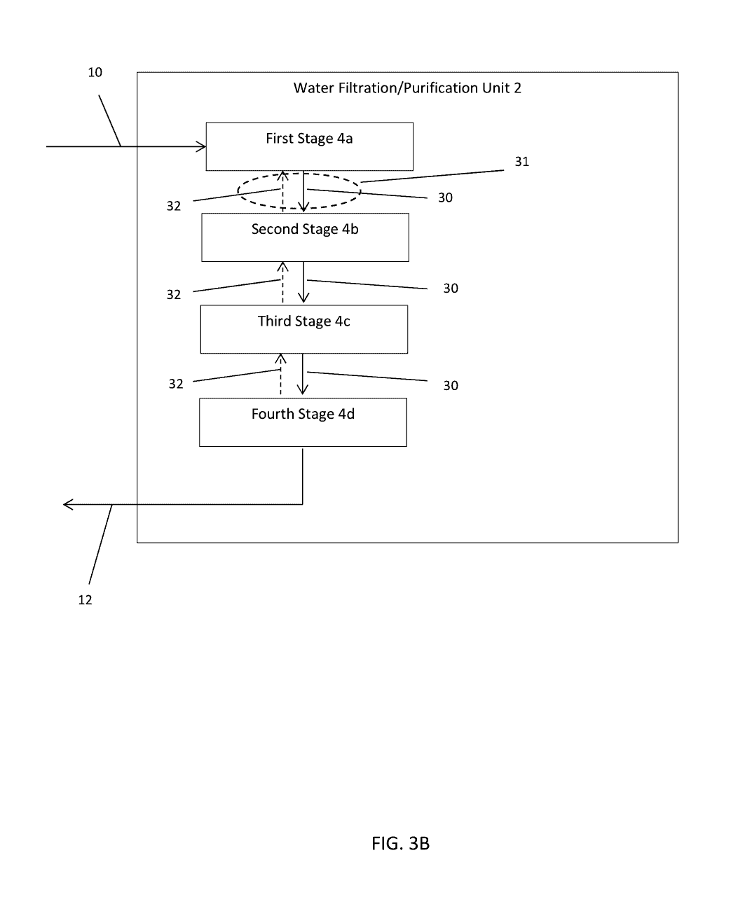

Referring to FIGS. 2-3, embodiments of the water filtration/purification unit 2 can include at least one stage 4. A first stage 4a can be at least one pre-filtration stage. A second stage 4b can be at least one ultra-filtration stage. A third stage 4c can be at least one osmosis stage. A fourth stage 4d can be at least one disinfection stage. It should be noted that any stage 4 can be a pre-filtration stage, an ultra-filtration stage, an osmosis stage, or a disinfection stage, and that the designation of the stages herein are exemplary. Further, there can be more than four stages 4 or less than four stages 4. Moreover, there can be multiple pre-filtration stages, multiple ultra-filtration stages, multiple osmosis stages, or multiple disinfection stages. Additionally, a system 1 can include a multi-stage arrangement of all pre-filtration stages, or all ultra-filtration stages, or all osmosis stages, or all disinfection stages. Any number of stages 4 and/or configuration of stages 4 can be used to implement any of the embodiments disclosed herein.

FIGS. 2A-2B show exemplary block diagrams of an embodiment of a three-stage water filtration/purification unit 2. FIGS. 2A-2B show the first stage 4a as the pre-filtration stage, the second stage 4b as the ultra-filtration stage, and the third stage 4c as the osmosis stage. FIGS. 3A-3B show exemplary block diagrams of an embodiment of a four-stage water filtration/purification unit 2. FIGS. 3A-3B show the first stage 4a as the pre-filtration stage, the second stage 4b as the ultra-filtration stage, the third stage 4c as the osmosis stage, and the fourth stage 4d as the disinfection stage. Any of the stages 4 can include a tank 28 (see FIG. 2A) to temporarily store water of a stage 4 or act as a reservoir for a stage 4. This may be done to accommodate fluctuations in water flow and/or water pressure. Some tanks 28 can include a conical shaped bottom to assist with proper mixing of the water. Some embodiments can include use of a heater/chiller unit 29. These can be placed anywhere within the system 1; however, it is contemplated for the heater/chiller units 29 to be placed between a tank 28, acting as a reservoir for a stage 4, and the stage 4 itself. This may be done to condition the temperature of the water stream entering the stage 4 from its associated tank 28. Other conditioning techniques for water streams of the system 1 can include changing acidity, changing the pH, addition of coagulation additives, etc. FIG. 2A shows an exemplary configuration with a tank 28 and a heater/chiller unit 29, both associated with the second stage 4b. This configuration can be applied any stage 4 and any other water filtration/purification unit 2 embodiment disclosed herein. Further, the tank 28 and heater/chiller unit 29 arrangement illustrated in FIG. 2A is exemplary, and other arrangements can be used.

For example, the first stage 4a can be configured to filter/purify water to a first level of purity, the second stage 4b can be configured to filter/purify water to a second level of purity, the third stage 4c can be configured to filter/purify water to a third level of purity, and the fourth stage 4d can be configured to filter/purify water to a fourth level of purity. The system 1 may be configured such that each subsequent stage 4 processes water to a greater degree of purity than the previous stage 4. For example, the fourth level of purity can be greater than the third level of purity. The third level of purity can be greater than the second level of purity. The second level of purity can be greater than the first level of purity.

In some embodiments, the water filtration/purification unit 2 can be configured to run in straight series. This can include causing a water stream to flow from a stage 4 to a subsequent stage 4 without recirculating back through the same or previous stage 4. An example of an embodiment of a straight series run flow can be seen in FIGS. 2A and 3A. The water stream can be caused to enter the water filtration/purification unit 2 at the first stage 4a. The water stream can then be directed to the second stage 4b. The water stream can then be directed to the third stage 4c. The water stream can then be directed to the fourth stage 4d (see FIG. 3A).

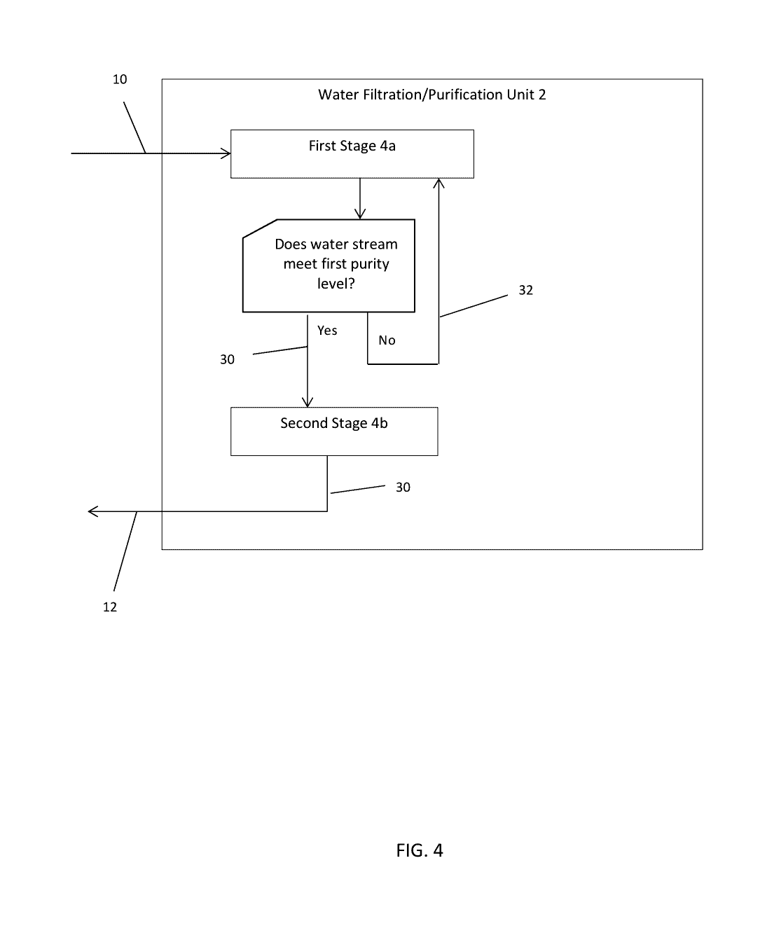

In some embodiments, the water filtration/purification unit 2 can be configured to run in recircular-series. This can include causing a water stream to flow from a stage 4 to a subsequent stage 4 and recirculating back through the same or previous stage 4. Exemplary embodiments of a recircular-series run flow can be seen in FIGS. 2B and 3B. With a recircular-series run configuration, the controller 16 can be configured to receive data from a sensor, for example, related to the level of purity the water stream exhibits as it exits each stage 4. If the water exiting a stage 4 does not have a level of purity expected by being processed by the stage 4 it exited, the controller 16 can cause the water to re-circulate back through the stage 4 the water just exited and/or a previous stage 4. Causing the water to re-circulate can include preventing the water from being directed to the next stage 4. For example, the water stream can be caused to enter the water filtration/purification unit 2 at the first stage 4a. As the water exits the first stage 4a, data can be transmitted to the controller 16 by a sensor for analysis. If the water purity is below the first level of purity (e.g., does not meet a level of purity defined by the first level of purity) the controller 16 can actuate a pump 24 and/or a valve 26 to cause the water to re-circulate back through the first stage 4a. (see FIG. 4). This may cause the water to be processed by the first stage 4a again and exit the first stage 4a to be analyzed again by the controller 16. If, upon exiting the first stage 4a, the water purity is at or above the first level of purity (e.g., meets a level of purity defined by the first level of purity), the controller 16 can actuate the pump 24 and/or valve 26 to cause the water to be directed to the second stage 4b, any other stage 4, and/or exit the system 1.

The same purification testing and recirculation scheme can be performed at any other stage 4. While the Figures show recirculation being defined as going back through the stage 4 the water stream just exited, this is just exemplary illustrations of a recirculation scheme. The water can be recirculated back through any stage 4. For example, the water stream exiting the third stage 4c can be recirculate back through the third stage 4c, the second stage 4b, and/or first stage 4a, etc. Recirculating the water stream can generate a recirculation loop 31. There can be more than one recirculation loop 31 within the system 1. For example, a recirculation loop 31 can include re-introduction of a water stream coming from a cross flow configuration of between the second stage 4b and the third stage 4c. Such re-introduction, as part of the recirculation, can result in minimal amounts of water loss across the system 1. For example, recirculation within the reverse osmosis stage 4c can greatly minimize water loss by not rejecting, to drain, the concentrate water. Current reverse osmosis based systems may only have a recovery rate of 70%, even with many multiple stages of reverse osmosis. The inventive system 1, however, can achieve a recovery of 90% with only two stages.

In some embodiments, the water filtration/purification unit 2 can be configured to run in parallel. This can include causing the water stream to split in two or more streams so that a stage 4 processing a divided water stream and another stage 4 processing another divided water stream can both process their respective divided water streams in parallel. It is contemplated that any combination of a straight series run, a recircular-series run, and a parallel run can be used with the water processing system 1.

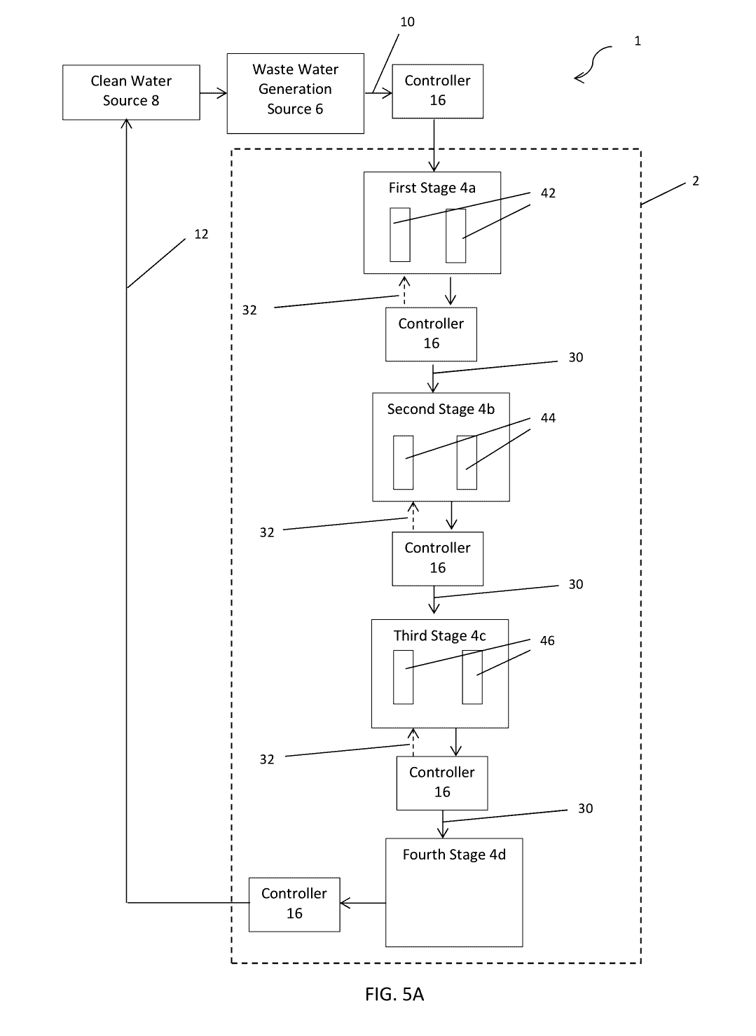

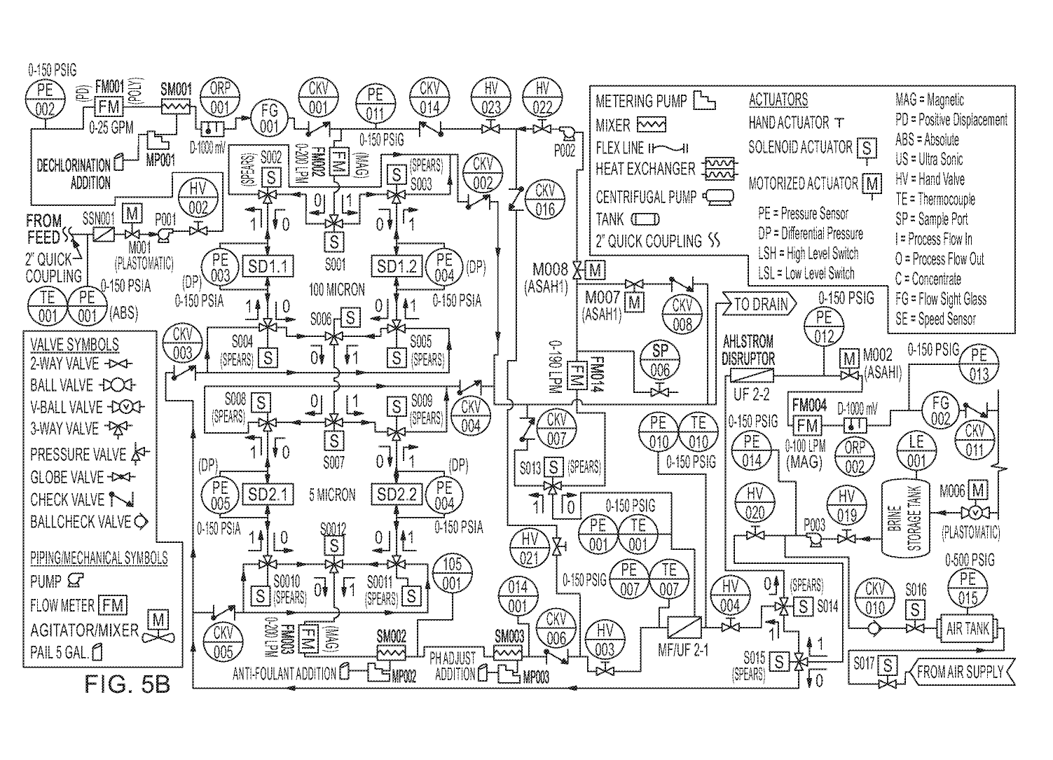

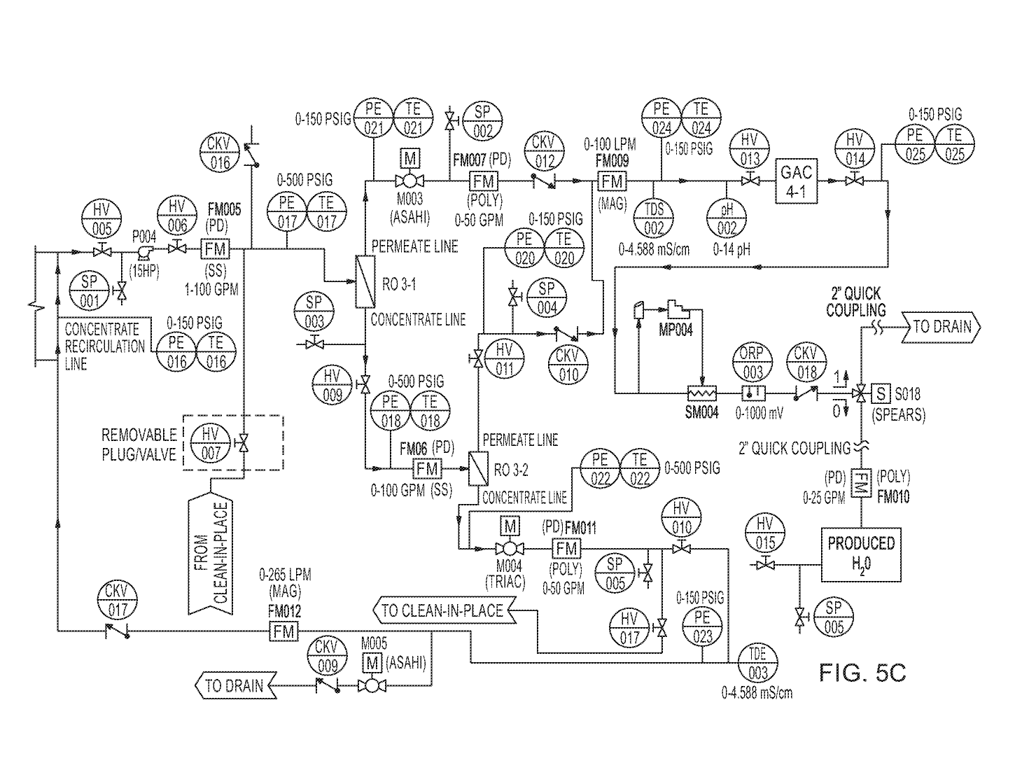

FIG. 5A shows an exemplary configuration of an embodiment of the water processing system 1 with a four-stage 4 water filtration/purification unit 2. FIGS. 5B-5C show an exemplary schematic that may be used to represent an embodiment of the system 1. Note that FIG. 5C is a continuation of FIG. 5B. The water processing system 1 can include a water filtration/purification unit 2 in connection with a waste water generation source 6. The waste water generation source 6 can be in connection with a clean water source 8. The clean water source 8 can be configured to supply usable water 12 to the waste water generation source 6. Usable water 12 can be defined as water having an acceptable level of impurities, clarity, particulate matter, etc. for a given function (e.g., drinking, bathing, laundry, potable water, non-potable water, etc.). The waste water generation source 6 (e.g., laundry machine, drain water from a shower, water from a processing plant, water that has been salinated, gray water or greywater, sullage, brackish water, salt/fresh water mixtures, etc.) can be a device or process that contaminates or pollutes the water to an unacceptable level, thereby generating waste water 10 that may not be suitable for usable water 12. The waste water 10 can be directed into the water processing system 1 as incoming water. Water flowing through the water processing system 1 can be referred to as the water stream. Water being passed from one stage to another stage can be referred to as passing water 30. Passing water 30 can be water that has been sufficiently purified and/or filtered by a desired reduction in particulate matter concentration and/or removal of a desired amount of particulates having a predetermined size, and is thus suitable for being transferred to the next stage 4, exit the water filtration/purification unit 2, be reused by the system 1, and/or to exit the system 1. Being suitable to exit the system 1 and/or reused by the system 1 can include being deemed usable water 12. Water being rejected by a controller 16 can be referred to as rejected water 32. Rejected water 32 can be water that has not yet been sufficiently purified and/or filtered, as described above, to be transferred to the next stage 4, be reused by the system 1, and/or to exit the system 1. Rejected water 32 can be water that is caused to be recirculated back into a stage 4 that the rejected water 32 has already been proceed through and/or be recirculated back through another stage 4. Water that can be used by the system 1 without further filtration and/or purification and/or water that can exit the water processing system 1 can be referred to as usable water 12.

The water filtration/purification unit 2 can include a first stage 4a in connection with a second stage 4b. The first stage 4a can be configured as a pre-filtration stage. The second stage 4b can be configured as an ultra-filtration stage. The second stage 4b can be in connection with a third stage 4c. The third stage 4c can be configured as an osmosis stage. The third stage 4c can be in connection with the clean water source 8. Alternatively, the third stage 4c can be in connection with a fourth stage 4d. The fourth stage 4d can be configured as a disinfection stage. The fourth stage 4d can be in connection with the clean water source 8. Connection between any of the stages 4, the clean water source 8, and the waste water generation source 6 can be facilitated by piping 22, valves 26, pumps 24, tanks 28, etc. The piping 22 can be configured to force the water stream to flow through each stage 4. The piping 22 can be configured to allow water to be able to flow through each stage 4 but to also be able to by-pass any stage 4. A system of pumps 24 and valves 26 can be used to cause a water stream to be forced to enter a stage 4 or by-pass a stage 4.

In some embodiments, at least one controller 16 can be placed between any of the stages 4, between the waste water generation source 6 and the water filtration/purification unit 2, and/or between the water filtration/purification unit 2 and the clean water source 8. Each controller 16 can be in connection with a sensor and other component (e.g., pump 24, valve 26, etc.) of the water processing system 1. Alternatively, there can be one controller 16 that is in connection with a plurality of sensors and/or components. Each controller 16 can be configured to receive sensor data, process the sensor data, and/or cause a component to perform a specified function. The sensor data can include, but are not limited to water stream flow rate, water stream volume, water stream pressure, temperature, conductivity, pH, power consumption of a component of the system 1, etc. The specified functions can include, but are not limited to, starting and/or stopping water stream flow, increasing and/or decreasing water stream flow, starting and/or stopping a pump 24, opening and/or closing a valve 26, etc. At least one controller 16 can be in communication with the computer device 18 and/or the computer system 20. The computer system 20 may have a plurality of computer devices 18 (see FIG. 1C). The computer device 18 can be used to transmit input commands to the controller 16. The input commands can cause the controller 16 to operate in a specified way and/or reprogram the logic of the controller 16.

In one implementation, usable water 12 can be transmitted to the waste water generation source 6 from the clean water source 8. The waste water generation source 6 can generate waste water 10. The waste water 10 can be directed to the water filtration/purification unit 2. The incoming waste water 10 can be directed to the pre-filtration stage 4a to be processed to the first purity level. The water stream exiting the pre-filtration stage 4a can be analyzed to determine if the water stream exhibits a purity of at least the first purity level. If the water stream has a purity that meets the first purity level, the water stream can be passed 30. If the water stream has a purity that does not meet first purity level, the water stream can be rejected 32 so as to not be passed. The rejected water stream 32 can be recirculated back into the pre-filtration stage 4a to be processed to the first purity level. The passing water stream 30 can be caused to exit the water filtration/purification unit 2, be reused by the water processing system 1, and/or exit the water processing system 1 if it is determined that the first purity level meets the purity acceptable for usable water 12. Alternatively, the passing water stream 30 can be directed to any other stage 4.

In one embodiment, the passing water stream 30 from the pre-filtration stage 4a can be directed to the ultra-filtration stage 4b to be processed to the second purity level. The water stream exiting the ultra-filtration stage 4b can be analyzed to determine if the water stream exhibits a purity of at least the second purity level. If the water stream has a purity that meets the second purity level, the water stream can be passed 30. If the water stream has a purity that does not meet the second purity level, the water stream can be rejected 32 so as to not be passed. The rejected water stream 32 can be recirculated back into the pre-filtration stage 4a and/or the ultra-filtration stage 4b to be processed to the first purity level or the second purity level, respectively. The passing water stream 30 can be caused to exit the water filtration/purification unit 2, be reused by the water processing system 1, and/or exit the water processing system 1 if it is determined that the second purity level meets the purity acceptable for usable water 12. Alternatively, the passing water stream 30 can be directed to any other stage 4.

In one embodiment, the passing water stream 30 from the ultra-filtration stage 4b can be directed to the osmosis stage 4c to be processed to the third purity level. The water stream exiting the osmosis stage 4c can be analyzed to determine if the water stream exhibits a purity of at least the third purity level. If the water stream has a purity that meets the third purity level, the water stream can be passed 30. If the water stream has a purity that does not meet the third purity level, the water stream can be rejected 32 so as to not be passed. The rejected water stream 32 can be recirculated back into the pre-filtration stage 4a, the ultra-filtration stage 4b, or the osmosis stage 4c to be processed to the first purity level, the second purity level, or the third purity level, respectively. The passing water stream 30 can be caused to exit the water filtration/purification unit 2, be reused by the water processing system 1, and/or exit the water processing system 1 if it is determined that the third purity level meets the purity acceptable for usable water 12. Alternatively, the passing water stream 30 can be directed to any other stage 4.

In one embodiment, the passing water stream 30 from the osmosis stage 4c can be directed to the disinfection stage 4d to be processed to the fourth purity level. The water stream exiting the disinfection stage 4d can be analyzed to determine if the water stream exhibits a purity of at least the fourth purity level. If the water stream has a purity that meets the fourth purity level, the water stream can be passed 30. If the water stream has a purity that does not meet the fourth purity level, the water stream can be rejected 32 so as to not be passed. The rejected water stream 32 can be recirculated back into the pre-filtration stage 4a, the ultra-filtration stage 4b, the osmosis stage 4c, or the disinfection stage 4d to be processed to the first purity level, the second purity level, the third purity level, or the fourth purity level, respectively. The passing water stream 30 can be caused to exit the water filtration/purification unit 2, be reused by the water processing system 1, and/or exit the water processing system 1 if it is determined that the fourth purity level meets the purity acceptable for usable water 12. Alternatively, the passing water stream 30 can be directed to any other stage 4.

The system 1 can be configured so that recirculation of the water stream through any one stage 4 or combination of stages 4 can occur once or more than once. The recirculation can be based on the acceptable purity level to transfer the water stream to the next stage 4 and/or to transfer the water stream out of the water filtration/purification unit 2 and/or the system 1. The recirculation can occur automatically for a set period of recirculation cycles. This can include a performing a recirculation cycle regardless of the purity level of the water stream. The recirculation can occur on a periodic basis, on a semi-periodic basis, on a time schedule, on a random schedule, etc. The recirculation can be based on a condition of the water filtration/purification unit 2 and/or the system 1 or a condition of the environment the water filtration/purification unit 2 and/or the system 1 is within. For instance, the recirculation can occur based on the pressure of the water stream, the flow rate of the water stream, particulate concentration of the water stream, particulate size of the particulates in the water stream, a differential pressure exhibited by the water stream, the humidity of the ambient air the water filtration/purification unit 2 and/or the system 1 is in, etc. For example, the humidity may affect the efficiency of one of the filtering mechanisms of a stage 4, and thus a recirculation cycle may be initiated based on humidity. Any of the conditions mentioned above can be set as a variable to be used by algorithms programmed in the controller 16 so that the controller 16 can determine when and how a recirculation scheme should be performed. Thus, a recirculation cycle can be initiated regardless of the controller 16 determining that the water stream is at or above an acceptable purity level. In addition, the purity level of the water can also be used as one of the variables. In at least one embodiment, a user can dictate the recirculation scheme for any stage 4 or multiple of stages 4. This can be done by entering command inputs via the computer device 18.

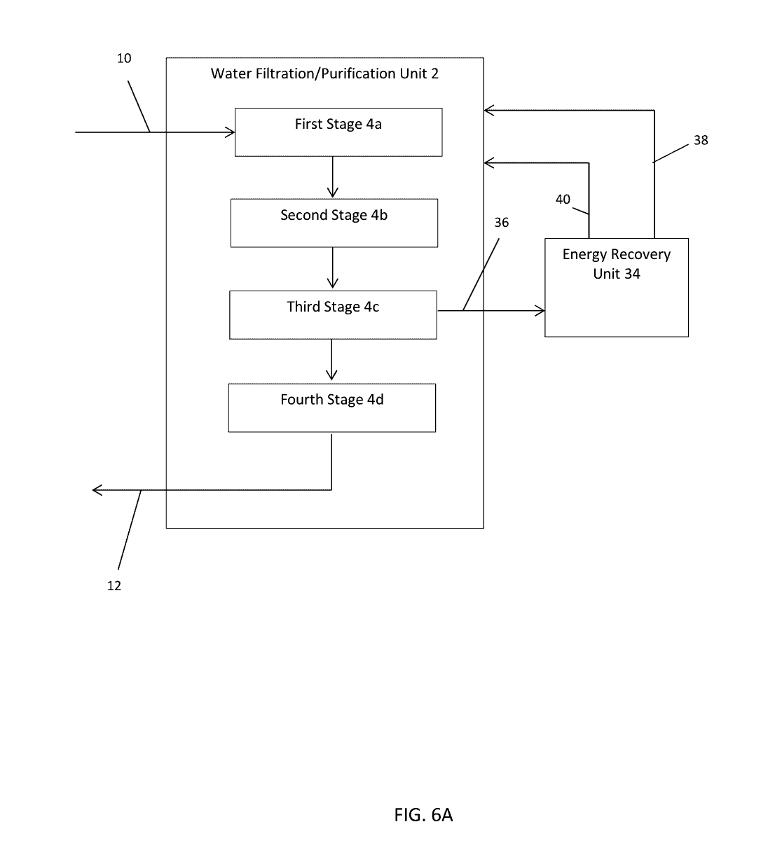

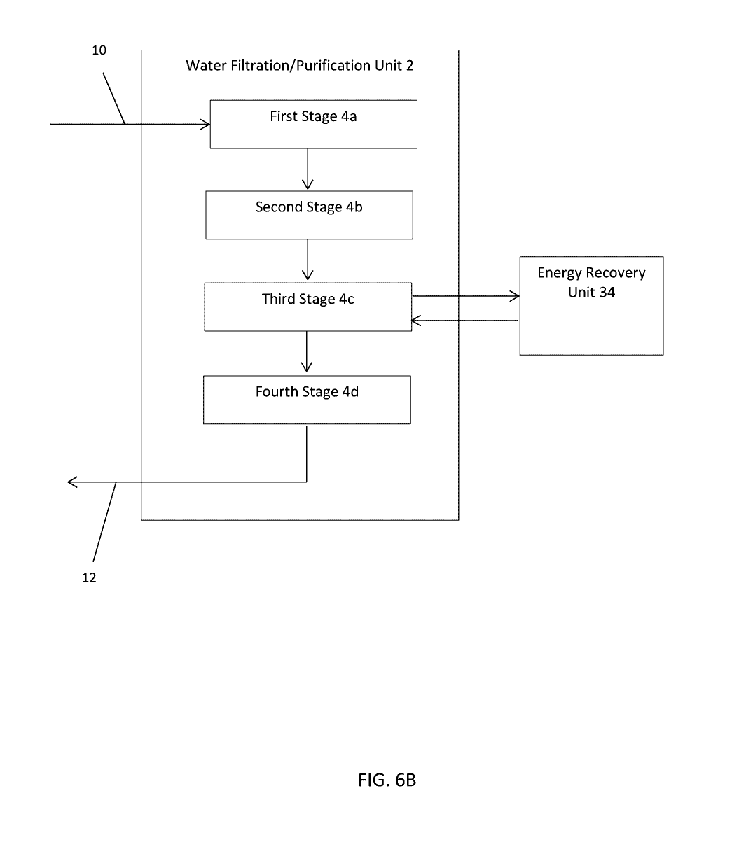

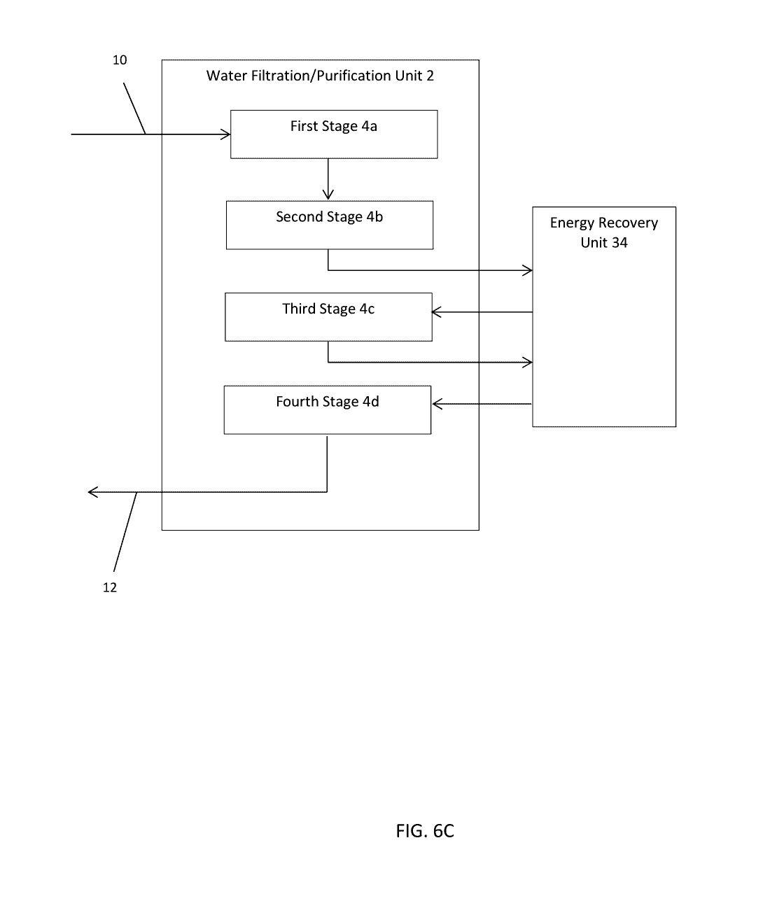

Referring to FIGS. 6A-6C, some embodiments may include use of an energy recovery unit 34. The energy recovery unit 34 can be a battery. (see FIG. 6A). The battery can be a flow battery configured to operate via electrolyte fluid being introduced into the battery system. The battery can be configured to use the reverse osmosis water stream as electrolyte fluid to generate electricity. For example, at least a portion of the water stream passing through the osmosis stage and/or exiting the osmosis stage can be directed to the battery to be used as electrolyte fluid. The water stream, after being used as electrolyte for the battery, may then be recirculated back into the water processing system 1. The controller 16 can be used to control and coordinate the flow of the water stream between the battery and the water processing system 1. For example, the controller 16 can be used to segregate the water stream of the osmosis stage 4c into a battery-designated waste stream 36 and a clean water stream. The battery-designated waste stream 36 can be directed to the battery. The clean water stream can be recirculated back into the water processing system 1 and/or directed for use as usable water 12.

A sensor can be used for detecting the electrolyte level of the battery-designated waste stream 36 before it is directed into the battery. This can include saline sensor to detect the saline level. The controller 16 can be used to compare the detected electrolyte level to a pre-determined level (e.g., an acceptable or optimal level) to be used as the electrolyte fluid in the battery. In some embodiments, electrolyte substances (e.g., salt) can be added to the battery-designated waste stream 36 to bring the electrolyte level of the battery-designated waste stream 36 to a desired level, which may be the pre-determined level. The battery may then be used to perform an oxidation reduction reaction, for example, to generate a first electrical energy 38. Hydrogen generated as a byproduct of the oxidation reduction reaction can be transferred to a hydrogen fuel cell to generate a second electrical energy 40. The hydrogen fuel cell can be part of the battery system or can be a separate energy recovery unit 34. At least a portion of any of the first and/or second electrical energy 38, 40 can be used to provide electrical power to the water processing system 1, which may include supplying electrical power to components of the osmosis stage 4c. Alternatively, or in addition, any portion of the first and/or second electrical energy 38, 40 can be stored, transfer to another energy consumption source, and/or converted to another form of energy.

Use of the battery as an energy recover unit 34 can facilitate water processing via the water processing system 1 with at least a 90% recovery rate. In some embodiments a 90% recovery rate can be achieved without energy being supplied by external power sources or power sources other than the battery unit. In some embodiments, use of the battery as an energy recovery unit 34 can allow for the reverse osmosis stage 4c to process fresh water and/or brackish water. In at least one embodiment, the water processing system 1 with the battery as the energy recovery unit 34 can be used for saltwater desalination.

In at least one embodiment, the system 1 can be configured to include any one stage 4 and the battery as an energy recovery unit 34. Some embodiments can include multiple stages 4 with the battery as an energy recovery unit 34. In some embodiments, a separate reverse osmosis process (one that is not within the water filtration/purification unit 2) can be used to generate the electrolyte fluid from the water stream being directed out from the system 1 and into the battery. For example, the system 1 can be configured as pre-filtration stage 4a only and in connection with the battery unit. This configuration may use a separate osmosis process. In at least one embodiment, the system 1 can be configured as a pre-filtration stage 4a in conjunction with a reverse osmosis stage 4c and a battery system as the energy recovery unit 34. This configuration may structure the pre-filtration stage 4a as a gravity-fed unit. Alternatively, the pre-filtration stage 4a can be configured to run in power mode.

In some embodiments, the battery can be configured as a magnesium-carbon battery. The system 1 with the magnesium-carbon battery may be used to generate ultra-filtered non-potable water at approximately 100 gallons per hour and/or potable water at approximately 10 gallons per hour (or 200 to 300 gallons per day). The magnesium-carbon battery can be a metal-air battery that may use magnesium as a fuel and the reverse osmosis water stream as electrolyte fluid to generate electricity. In some embodiments, the magnesium-carbon battery can include a magnesium anode coupled with a carbon-based air cathode. An exemplary magnesium-carbon battery unit that may be used with the system 1 as an energy recovery unit 34 is disclosed in U.S. Pat. No. 9,156,714, titled “Energy Generation System and Related Uses Thereof,” which is incorporated herein by reference in its entirety.

Referring to FIG. 6B, additionally or in the alternative, the system 1 can include a pressure exchanger as an energy recovery unit 34. The pressure exchanger can be configured to transfer pressure energy from a high pressure fluid stream to a low pressure fluid stream. There may be fluctuation in pressure within the system 1 that can generally be bled off via a throttle valve 26. This pressure can be redirected by the pressure exchanger instead of being bled off. The pressure can be redirected to the same stage 4, another stage 4, or to any other portion of the system 1. For example, the pressure exchanger can be configured for use with the high pressure feed of the reverse osmosis stage 4c to redirect any undesired increase in pressure or any surplus of differential pressure to another portion of the system 1.

Referring to FIG. 6C, additionally or in the alternative, the system 1 can include an educator as an energy recovery unit 34. For example, the reverse osmosis stage can be configured for high recovery rate and low energy input via use of the eductor. At least one eductor (e.g., a jet pump) can be used to reduce stream pressure of any rejected water 32 that exists the reserve osmosis stage. The eductor can also be used to increase stream pressure of the water stream entering the reverse osmosis stage 4c (e.g., the water stream entering the pump 24 of the osmosis stage). Use of the eductor can significantly reduce energy consumption. For example, as much as a 30% reduction in energy consumption can be achieved within the reverse osmosis stage 4c by using the jet pump 24 as an energy recovery unit 34.

Total system energy consumption of approximately 9 kilo-Watts (“kW”) can be achieved under a steady state load without use of any of the embodiments of the energy recovery unit 34. The total system energy consumption can be reduced to approximately 7.8 kW under a steady state load with the use of embodiments of the energy recovery unit 34.

The water processing system 1 can take in waste water 10 and can generate usable water 12, which may be achieved via filtration and/or purification techniques at any stage 4. Such techniques can include mechanical filtration, ultrafiltration, desalination, reverse osmosis, and/or disinfection. Any one filtration mechanism and/or combination of filtration mechanisms can include reducing the concentration of particulate matter and/or suspended particles in the waste water 10 to an acceptable level so as to be adequate for usable water 12. For example, a filtration technique can include use of filters and/or membranes that act to sieve particulate matter of a predetermined size to reduce the particulate concentration of the waste water 10.

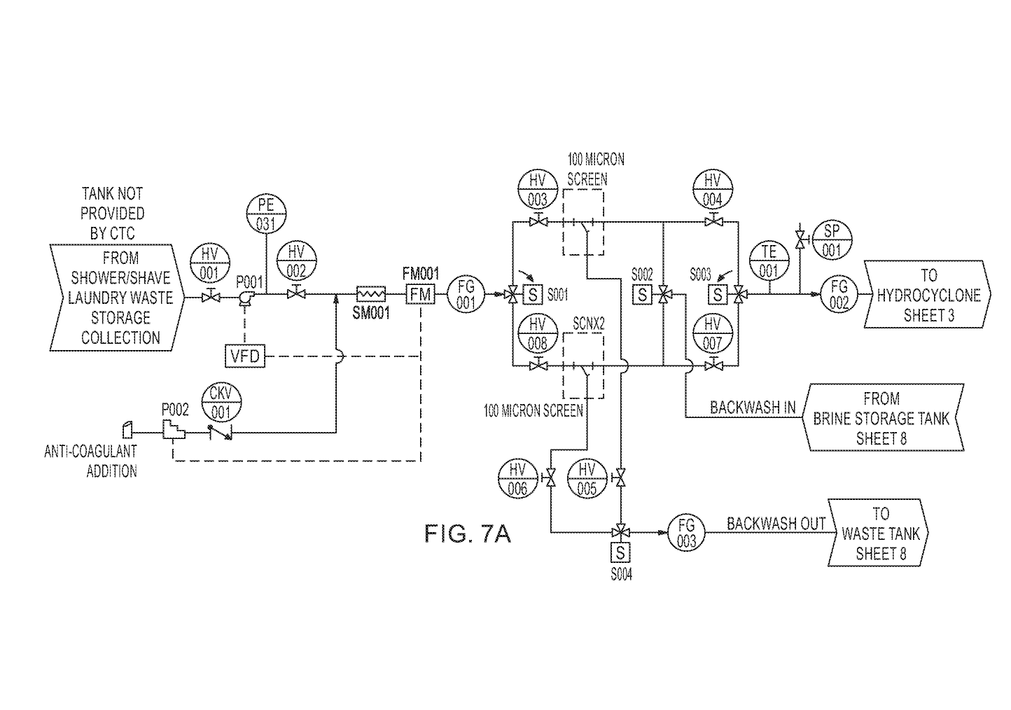

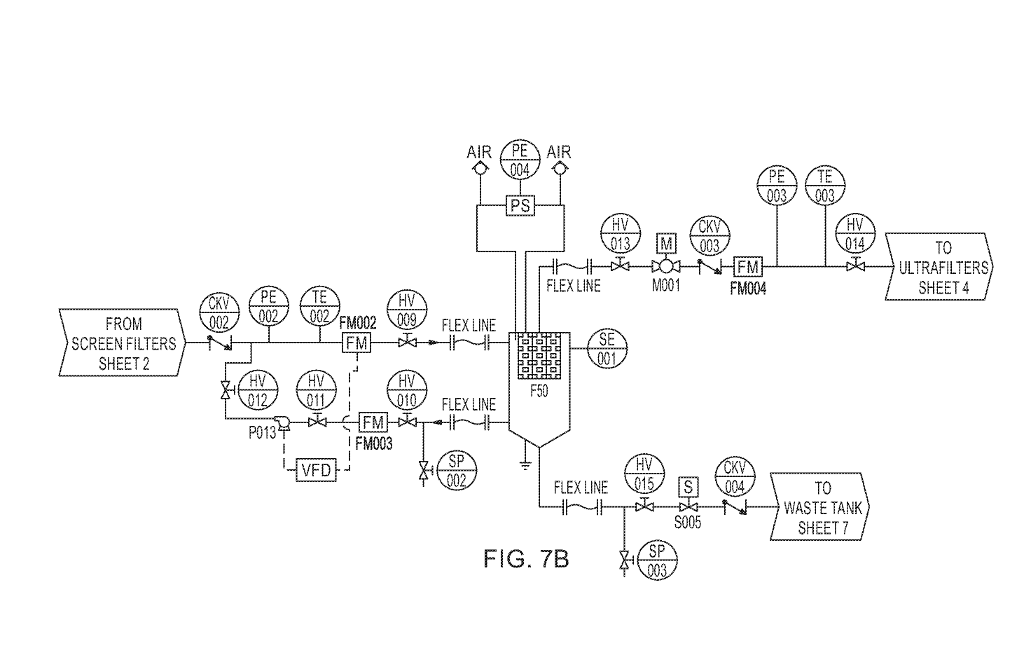

FIGS. 7A-7B show exemplary schematics of embodiments of pre-filtration stages that may be used with the water processing system 1. While it is contemplated for the first stage 4a to be configured as a pre-filtration stage, any stage 4 can be a pre-filtration stage. The pre-filtration stage may be performed through mechanical filtration via at least one pre-filtration filter 42. The pre-filtration filter 42 can be a mechanical stack filter, a stacked disc filter, a hydrocyclone filter, etc. In some embodiments, there can be a plurality of pre-filtration filters 42. For example, the pre-filtration stage can include a plurality of stacked disc filters. Filtration of the water stream can be achieved by forcing the water stream through the pre-filtration filter 42 by generating a pressure differential within the water stream. The pre-filtration stage can be used to reduce the particulate level of the water stream passing through it.

In at least one embodiment, the pre-filtration stage includes a first disc filter and a second disc filter that may be stacked in series. The first disc filter can be a 100-micron filter. The second disc filter can be a 5-micron filter. Some embodiments can include at least one hydrocyclone filter and/or at least one deadhead-type filter instead of or in addition to the stacked filters.

Mechanical filtration by embodiments of the pre-filtration stage can reduce particulate matter concentrations of a water stream. For example, a water stream having greater than 50 Nephelometric Turbidity Units (“NTU”) can be reduced to below 25 NTU. Thus, in some embodiments, the first purity level can be set for a particulate matter concentration of 25 NTU and below. It is contemplated, for example, for the pre-filtration stage to operate within a pressure range from 50 to 70 pounds per square inch (“psi”). The pressure range from 50 to 70 psi can drive the water stream through the circulation circuit of the system 1. The pressure range from 50 to 70 psi can also control backwash. For example, once a pressure differential is reached across the pre-filtration filters 42, the pre-filtration filters 42 can be automatically backwashed. For example, the controller 16 may automatically senses a differential pressure across any of the filters (pre-, ultra-, etc.) and thereby “set” a backwash. The system 1 may then automatically go through a backwash sequence. Backwashing the pre-filtration filters 42 can significantly reduce maintenance of the pre-filtration filters 42.

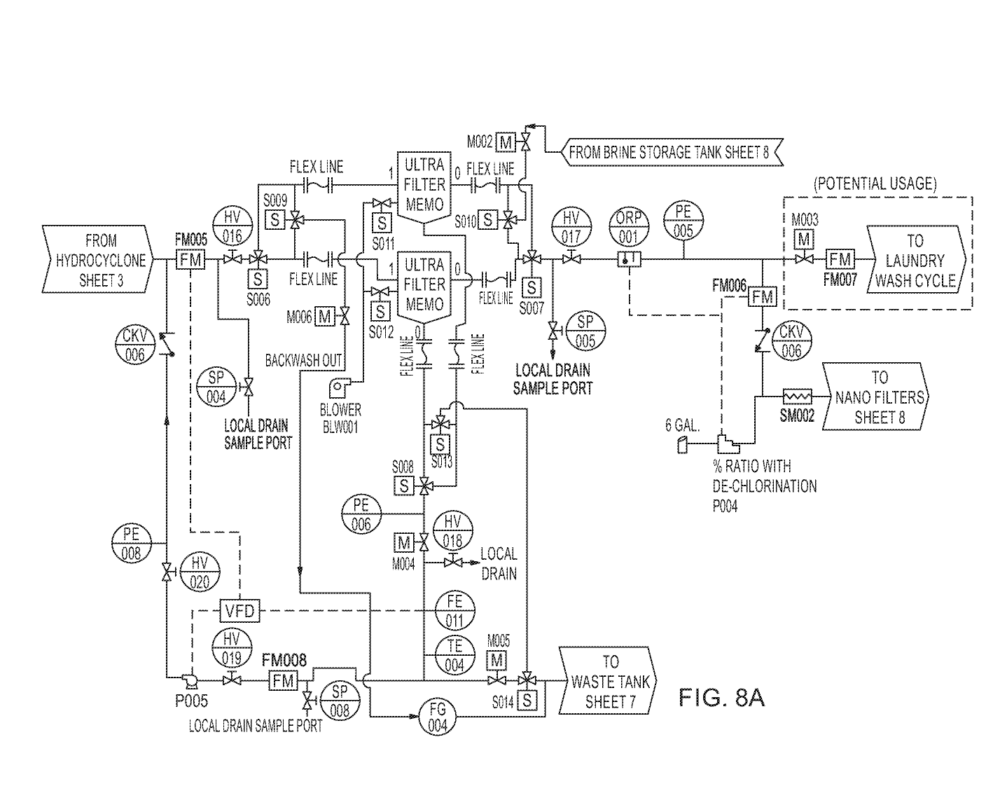

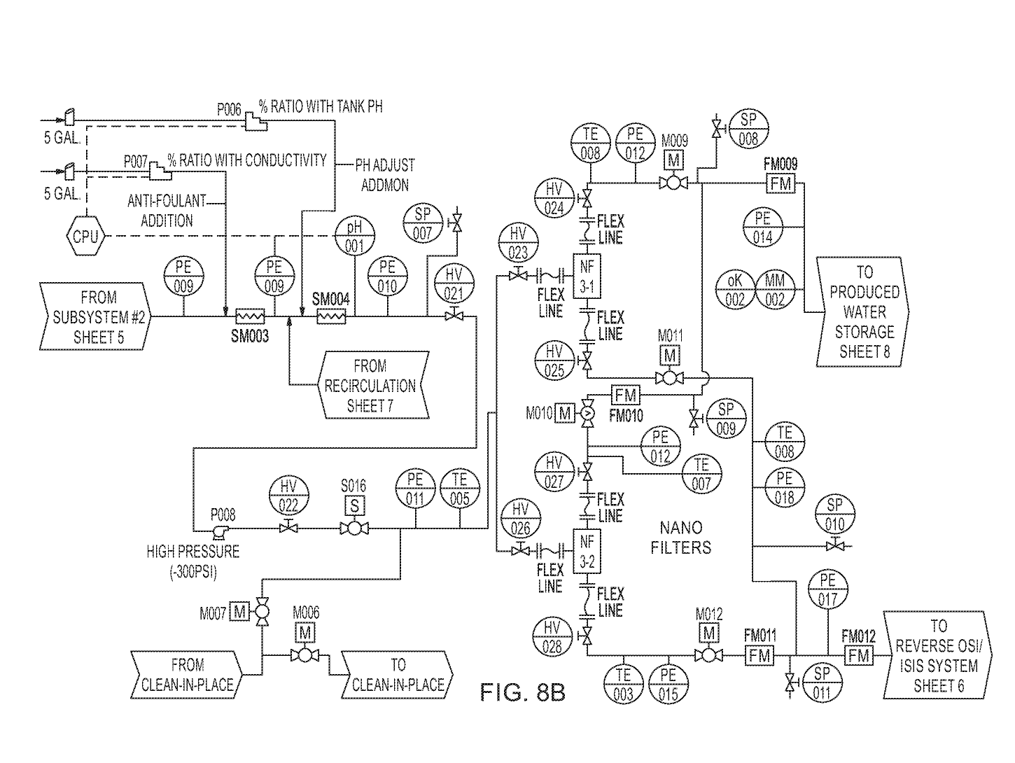

FIGS. 8A-8B show schematics of exemplary ultra-filtration stages that may be used with the water processing system 1. While it is contemplated for the second stage 4b to be configured as an ultra-filtration stage, any stage 4 can be an ultra-filtration stage. The ultra-filtration stage can be a micro-, an ultra- (see FIG. 7A), and/or a nano- (see FIG. 7B) filtration process. The ultra-filtration stage may be performed through separation of particulates through at least one ultra-filtration semipermeable membrane 44. The ultra-filtration semipermeable membrane 44 can include, but is not limited to, a ceramic ultra-filter, a ceramic micro-filter, a spiral-wound micro-filter, a spiral-wound ultra-filter, a spiral-wound nano-filter, silicon carbide filter, etc. The separation of particulates can be achieved by forcing the water stream through the ultra-filtration semipermeable membrane 44 by generating a pressure differential within the water stream. The ultra-filtration semipermeable membrane 44 can be configured such that suspended particulates at 0.01 microns and above may be retained in a retentate, while water and particulates less than 0.01 microns can pass through the ultra-filtration semipermeable membrane 44 into a permeate. The ultra-filtration stage can also generate a water stream exhibiting a NTU of less than one. The ultra-filtration stage can also generate a water stream with a Silt Density Index (“SDI”) of 2.0 or less. Thus, in some embodiments, the second purity level can be set for a water stream containing suspended particulates having a size of 0.1 microns or less, set for a water stream exhibiting a NTU of one or less, and/or set for a water stream exhibiting a SDI of 2.0 or less.

In some embodiments, a spiral wound micro-filter (7640 configuration, 0.2 micron) can be used as the ultra-filtration semipermeable membrane 44. In some embodiments, an activated alumina filter (2.5″×20″ configuration, 0.02 micron) can be used as the ultra-filtration semipermeable membrane 44. Other spiral-wound filter media, hollow-fiber filter media, ceramic filter media, etc. can be used. In some embodiments, the ultra-filtration stage can polish the water stream to sufficient quality for reuse in non-potable manners (e.g., laundry). In some embodiments, in order for the water stream to be processed by the osmosis stage, it must be passed through the ultra-filtration stage. For example, some osmosis stages may be configured to require a water stream input exhibiting a maximum SDI level. Thus, some osmosis processes may not be effective unless a water stream entering the process has a SDI of less than 5.0. Embodiments of the ultra-filtration stage can be configured to generate a water stream with a SDI of less than 5.0, and some embodiments can generate a water stream with a SDI of approximately 2.0 or less. Thus, an osmosis stage can be configured to require a water stream entering the process having a SDI of less than 2.0.

It is contemplated, for example, for the ultra-filtration stage to operate within a pressure range from 50 to 70 pounds per square inch (“psi”). The pressure range from 50 to 70 psi can drive the water stream through the circulation circuit 31 of the system 1. The pressure range from 50 to 70 psi can also control backwash. For example, once a pressure differential is reached across the ultra-filtration semipermeable membranes 44, the ultra-filtration semipermeable membrane 44 can be automatically backwashed. Backwashing the ultra-filtration semipermeable membrane 44 can significantly reduce maintenance of the ultra-filtration semipermeable membrane 44.

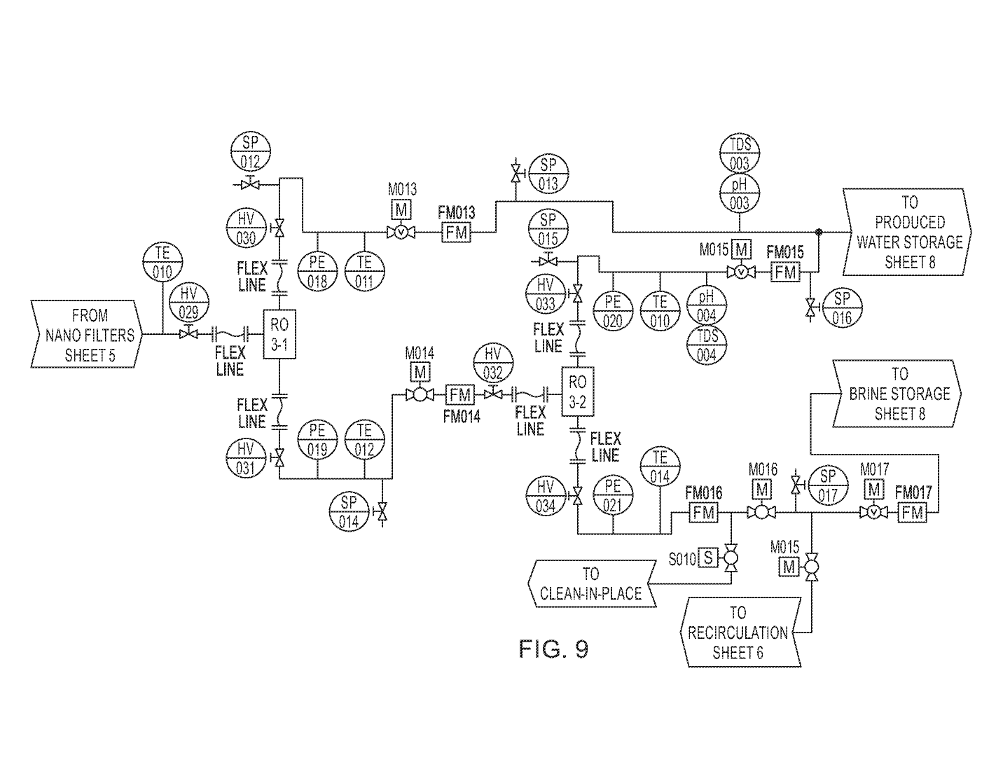

FIG. 9 shows a schematic of an exemplary osmosis stage that may be used with the water processing system 1. While it is contemplated for the third stage 4c to be configured as an osmosis stage, any stage 4 can be an osmosis stage. The osmosis stage may be configured as a reverse osmosis stage. The reverse osmosis stage may be performed through at least one osmosis semipermeable membrane 46 with a pressure applied to overcome at least some of the osmotic pressure experienced by the water stream. The osmosis semipermeable membrane 46 can include, but is not limited to a brackish-water reverse osmosis membrane, a wastewater specific reverse osmosis membrane, etc. Minimal particulate matter and other dissolved solids (e.g., dissolved salts) can be retained (e.g., retentate) on the pressurized side of the osmosis semipermeable membrane 46 while the purified water can be made to pass (e.g., permeate) through osmosis semipermeable membrane 46. The reverse osmosis stage can generate a water stream exhibiting a TDS of 500 ppm or less. Thus, in some embodiments, the third purity level can be set for a water stream containing total dissolved solids of 500 ppm or less.

Some embodiments can include a plurality of osmosis semipermeable membranes 46. At least two osmosis semipermeable membranes 46 of the plurality osmosis semipermeable membrane 46 can be arranged in series. One embodiment can include four osmosis semipermeable membranes 46 arranged in series. The osmosis semipermeable membrane 46 can include a 8040 spiral-wound reverse osmosis membrane. It is contemplated, for example, for the reverse osmosis stage to operate within a pressure range from 120 to 250 psi. The pressure range from 120 to 250 psi can drive the water stream through the osmosis semipermeable membrane 46. The pressure range from 120 to 250 psi can provide a motive force for the recirculation loop 31 of the osmosis stage.

In at least one embodiment, the retentate can be included in the rejected water stream 32 of the osmosis stage. The rejected water stream 32 containing the retentate of the osmosis stage can be recirculated. The recirculation loop 31 may be defined as recirculating the rejected water 32 back through the osmosis stage. In one embodiment, the retentate may be drained from the recirculation loop 31. The drained retentate can be used to support backwashing operations of a stage 4. For example, the retentate can be drained from the recirculation loop 31 of the reverse osmosis stage that is recirculating rejected water 32 back into the osmosis stage so that it can be directed to another stage 4 for backwashing operations. In one embodiment, the controller 16 can be programmed to monitor the rejected water stream 32 of the osmosis stage. This can be on a continuous, semi-continuous, periodic, etc. basis. For example, the controller 16 can monitor the rejected water stream 32 within the reverse osmosis stage for TDS levels. The detected TDS level can be compared to a pre-set TDS level. The pre-set TDS level can be 16,000 parts per million (“ppm”) or greater, for example. If the detected TDS level is greater than a pre-set TDS level, the rejected water stream 32, or at least a portion containing the retentate, can be caused to exit the recirculation loop 31. The controller 16 can be further programmed to direct at least a portion of the drained retentate water to a backwash tank for backwash operations within the pre-filtration and/or ultra-filtration stages. The controller 16 can be further programmed to direct retentate water that is contaminated only with dissolved solids to the backwash tank. In at least one embodiment, control logic can be used to optimize backwash recirculation and/or to increase overall processing rates of the system 1. In some embodiments, backwashing the pre-filtration and/or ultra-filtration stages may facilitate the reverse osmosis stage to be restarted with “fresh” water coming from restarts of the ultra-filtration stage.

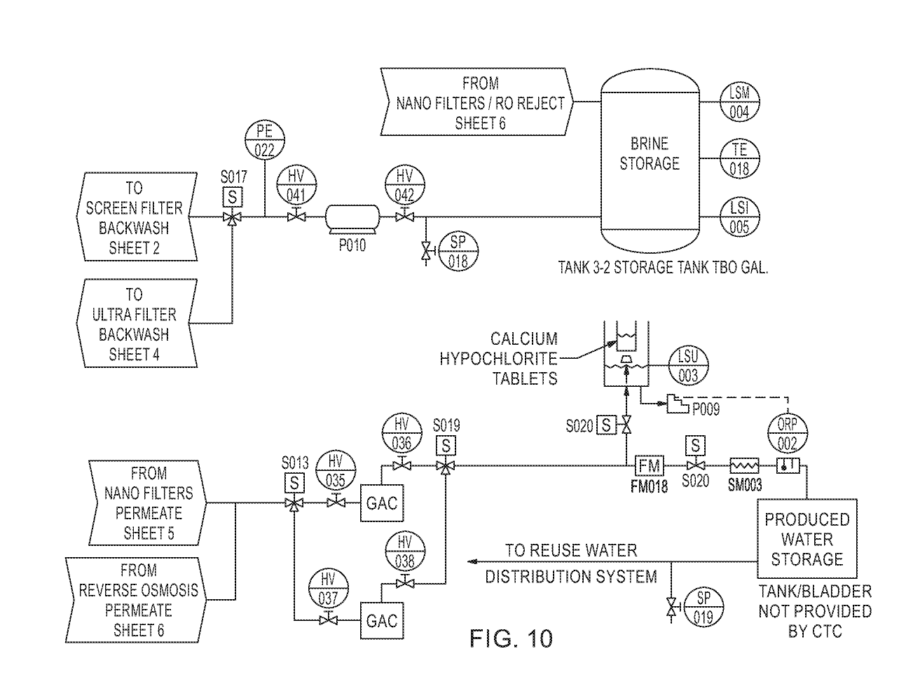

FIG. 10 shows a schematic of an exemplary disinfection stage that may be used with the water processing system 1. While it is contemplated for the fourth stage 4d to be configured as a disinfection stage, any stage 4 can be a disinfection stage. The disinfection stage may be performed via introduction of an oxidizer agent (e.g., chlorine), application of ultraviolet radiation, etc. Some embodiments can include means to test for and/or modify water characteristics. This can include testing for and/or modifying pH, conductivity, etc. The disinfection stage can generate a water stream that exhibits less than a Maximum Contaminant Level (“MCL”) for a given contaminant(s). This may include a MCL so as to make the usable water 12 acceptable for drinking. The MCL may depend on the contaminant detected and/or expected to be present within the water stream. Some examples of MCL levels can be 0.0±0.05 mg/L of cryptosporidium, 0.0±0.05 mg/L Legionella, 0.0±0.05 mg/L of viruses, 0.0±0.05 mg/L of Bromate, 0.8 mg/L of Chlorite, 2.0 mg/L of Barium, 0.0±0.05 mg/L of Arsenic, 0.004 mg/L of Beryllium, 0.0±0.05 mg/L of Lead, 0.002 mg/L of Mercury, 0.0±0.05 mg/L of Benzene, 0.0±0.05 mg/L of Arcylamide, 0.6 mg/L of o-Dichlorobenzene, 0.05 mg/L of Hexachlorocyclopentadiene, etc. The acceptable levels of contaminants can be set by regulatory agencies of a government agency, such as the United States Environmental Protection Agency (“EPA”) for example. Thus, in some embodiments, the fourth purity level can be set for a water stream containing less than the EPA designated MCL for at least one contaminant. An exemplary list of contaminants and MCLs can be found at https://www.epa.gov/ground-water-and-drinking-water/table-regulated-drinking-water-contaminates#one.

Any of the stages 4 can include a plurality of pre-filtration filters 42, ultra-filtration semipermeable membranes 44, and/or osmosis semipermeable membranes 46. These filters and/or membranes 42, 44, 46 can be arranged in various configurations within the stage 4. For example, any of the filters and/or membranes 42, 44, 46 can be arranged in series, parallel, or any combination thereof. The different arrangements can be used to achieve a desired result and/or effectuate an implantation of an embodiment of the system 1.

In some embodiments, the water processing system 1 can be configured to reduce energy demand by reducing and/or eliminating heating requirements for the system 1. For instance, any of the components of the system 1, pre-filtration filters 42, ultra-filtration semipermeable membranes 44, osmosis semipermeable membranes 46, etc. can be selected for wide temperature variance operations. This can include selection for high-temperature tolerances. Thus, embodiments can be used to process water through any one stage 4 or multiple of stages 4, where the water is within a temperature range from 34 Fahrenheit (° F.) to 150° F. Water within a temperature range from 34 degrees ° F. to 150° F. can be processed through the system 1 without degradation or destruction of any of the components of the system 1, pre-filtration filters 42, ultra-filtration semipermeable membranes 44, osmosis semipermeable membranes 46, etc. Because water at increased temperatures can be processed, the usable water 12 exiting the system 1 and/or being reused by the system 1 can still have heat energy stored within it. For example, the usable water 12 exiting the system and/or being reused by the system 1 can be at a temperature of 100° F., which may be beneficial if the usable water 12 is directed back to a waste water generation source 6 that requires latent heat water for its operations (e.g., a shower, a laundry machine, etc.). In other words, the usable water 12 does not have to be reheated much or at all to be reused at a desired temperature.

FIG. 11 shows an exemplary configuration of an embodiment of a water processing system 1 that include a housing structure 50. The system 1 can include a housing 50 to contain at least one stage 4, the piping 22, valves 26, pumps 24, etc. The housing 50 can be structured for use in a remote environment that may be subjected to the elements (e.g., inclement weather, etc.). For example, the housing 50 can be fabricated from metal, plastic, etc. The housing 50 may include corrugated panels so as to provide additional rigidity and stability to the housing structure. The housing 50 can be structured for portable use. This can include fork-lift tine feedthroughs 52. Some embodiments can include feedthroughs 52 located at a bottom of the housing 50. The exemplary embodiment of FIG. 11 shows the housing 50 structured as a square unit with a first stage 4a having two pre-filter units, a second stage 4b having three ultra-filter units, and a third stage 4c having a reverse osmosis unit. The stages 4 can be inter-connected via piping 22 and valves 26. At least one controller 16 can be included within the piping arrangement 2. At least one pump 24 can be included within the piping arrangement 22 to supply differential pressures and drive the water stream.

Embodiments of the water processing system 1 can be configured to be in connection with at least one computer device 18 and/or a computer system 20, and FIG. 12 shows an exemplary user interface 48 that may be displayed via the computer device 18. The user interface 48 can be a model representation of an embodiment of a water processing system 1. The user interface 48 can also facilitate real-time monitoring of the system 1. For example, data from the sensors and other components of the system 1, as well as data from the controllers 16 can be transmitted to the computer device 18 so that tracking and statistical information about the system's 1 operation can be displayed in real-time. The data can be transmitted via a transceiver device or other kind of data transmission device. The user interface 48 can also allow a user to enter command inputs that may be transmitted from the computer device 18 to any component and/or controller 16. The command inputs can cause the system 1 to function in a particular way and/or cause the system 1 to transmit specific types of data for analysis back to the computer device 18. Various user interfaces 48 can be generated to display models and schematics of the system 1. The various user interfaces 48 can further facilitate user command and control of the controller(s) 16 and/or other system components. For example, controllers 16 can be programmed to measure parameters of the system 1 so as to determine operating variables that would yield efficient operation. Such programming can be changed and/or updated via command inputs sent from the computer device 18.

Any of the stages 4, or combination of stages 4, can be used to reduce the concentration of particulate matter and suspended particles within unpurified water. This may include the reduction of organic matter/particles (e.g., parasites, bacteria, algae, viruses, fungi, etc.) or inorganic matter/particles (e.g., clay, silt, aluminum sulfate, iron chloride, etc.). In addition, or in the alternative, the system 1 can further reduce the salinity of water. In some implementations, the system 1 can facilitate specific configurations that may include energy efficient components. For example, the operation of the system 1 can be optimized so as to facilitate at least one of: 1) minimize pump power requirements; 2) minimize operational pressures; 3) achieve optimal trans-membrane and reverse osmosis pressures; 4) achieve optimal backwash/back-pulse intervals; and, 5) achieve anti-fouling capabilities. This can be achieved via selection of the components of the system 1, pre-filtration filters 42, ultra-filtration semipermeable membranes 44, osmosis semipermeable membranes 46, etc. Some embodiments can allow for filtration of gray water or greywater and/or brackish water with minimal expenditure of energy.

Some embodiments can reduce the concentration of particulate matter and/or dissolved solids contained in water from greater than 50 NTU and/or 3,000 ppm, respectively, to less than 1 NTU and/or 500 ppm, respectively, at 15,000 gallons per day, at a power consumption of 9 kW and at a recovery rate of greater than 90%. This may be referred to as a full-scale operation. Other embodiments can reduce concentration of particulate matter and dissolved solids from greater than 50 NTU and/or 3,000 ppm to less than 1 NTU and/or 500 ppm, respectively, at 200 to 300 gallons per day, without external power sources, and at a recovery rate of greater than 90%. This may be referred to as a reduced-scale operation. Any of the full-scale and/or reduced-scale operations can include use of the battery as the energy recovery unit 34. For example, the reduced-scale operation may include the use of the battery unit as an energy recovery unit 34 to significantly reduce and/or eliminate use of an external power source. In some implementations, the operational characteristics of both the full-scale and reduced-scale operations identified herein can be achieved even with a relative humidity of up to 95% and/or with the system 1 operating at an altitude of up to 10,000 feet above sea level. This may be achievable through correct selection of components and proper control of the system 1 to allow operation at these environments.

The system 1 can be used to recover up to 90% of waste water 10 that may otherwise be disposed of. For example, the system 1 can be used to circulate laundry drainage water and shower drainage water to be reused for the same purposes with up to 90% recovery or more. Furthermore, waste water 10 processed through an embodiment of the system 1 can provide up to 36%+of the waste stream water 10 for toilet and urinal usage. The high recovery rate and low energy input exhibited by the system 1 can significantly reduce demand on infrastructure, reduce demand on fossil fuel usage, and/or minimize labor and/or maintenance requirements. For example, some embodiments may facilitate operation of an embodiment of the system 1 without replacement of pre-filtration filters 42, ultra-filtration semipermeable membranes 44, and/or osmosis semipermeable membranes 46. However, any of the pre-filtration filters 42, ultra-filtration semipermeable membranes 44, and/or osmosis semipermeable membranes 46 can be removed easily from the system for cleaning and/or replacement. Other embodiments can be configured to use few, if any, consumable component parts.

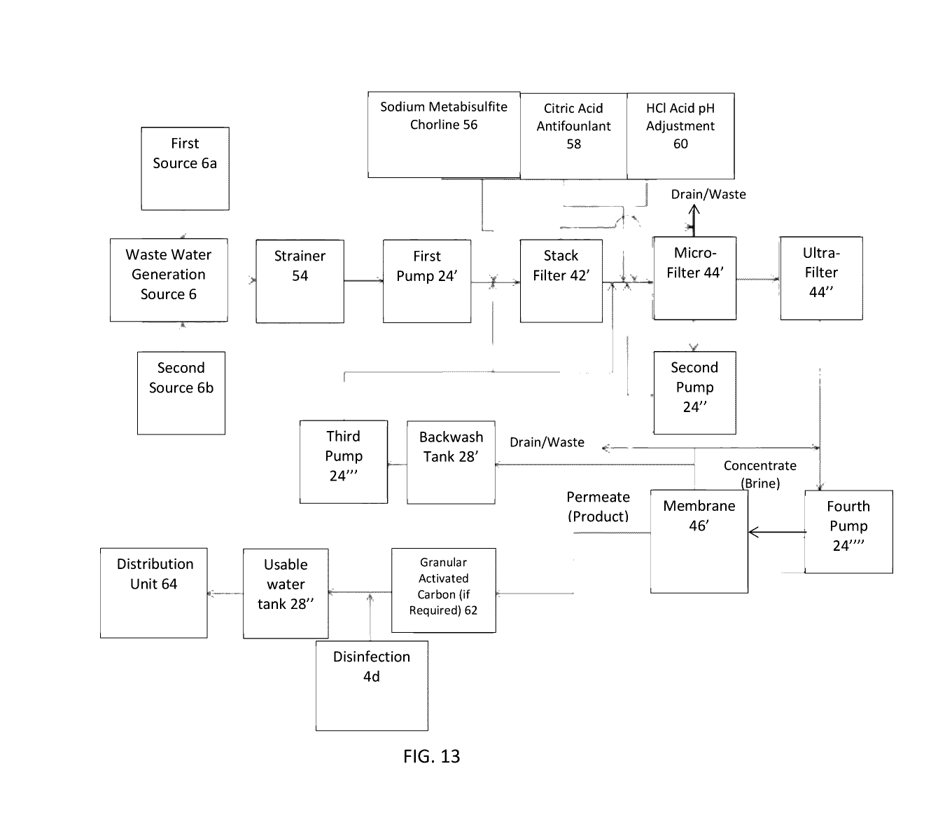

FIG. 13 shows an exemplary block diagram of another embodiment of the water processing system 1. The waste water generation source 6 can include a first source 6a (e.g., shower) and a second source 6b (e.g., laundry). The waste water generation source 6 may flow through a strainer 54 before being directed by a first pump 24′. The first pump 24′ can direct the waste water 10 to the first stage 4a (e.g., pre-filtration having at least one stacked disc filter 42′). Alternatively, or in addition, the waste water 10 may be treated before entering the first stage 4a. The treatment may include at least one of a sodium metabisulfite chlorine reduction treatment 56, a citric acid antifoulant treatment 58, and a hydrochloric acid (HCl) pH adjustment treatment 60. The water stream can then be caused to pass 30 to a second stage 4b (e.g., an ultra-filtration stage), which may include a micro filter 44′ and an ultra filter 44″. The water stream can enter the micro filter 44′ first. Rejected water 30 from the micro filter 44′ can be recirculated back through the micro filter 44′ by a second pump 24″. Passing water 30 from the micro-filter 44′ can be passed to the ultra filter 44″. A controller 16 can examine the rejected water 32 from the ultra filer 44″ to determine if any portion of it should be directed to the backwash tank 28′. The controller 16 can also determine when the third pump 24′″ should direct water from the backwash tank 28′ to the first stage 4a. The passing water 30 from the second stage 4b can be directed to the third stage 4c (e.g., a reverse osmosis stage) via a fourth pump 24″″. The third stage 4c can include a semi-permeable membrane 46′. The passing water 30 from the semi-permeable membrane 46′ can be further treated. This can include a granular activated carbon 62 process, which may include silver disinfection. Alternatively, or in addition, the passing water 30 from the semi-permeable membrane 46′ can be transferred to the fourth stage 4d (e.g., a disinfection stage). Passing water 30 exiting the fourth stage 4d can be usable water 12 to be stored in a usable water tank 28”. A distribution unit 64 can take usable water 12 from the usable water tank 28″ for distribution.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features disclosed herein. Therefore, it is the intent to cover all such modifications and alternative embodiments as may come within the true scope of this invention, which is to be given the full breadth thereof. Additionally, the disclosure of a range of values is a disclosure of every numerical value within that range, including the end points.

We claim:

1. A water processing unit, comprising:
at least one stage comprising a pre-filtration unit, an ultra-filtration unit, an osmosis unit, and/or a disinfection unit, the at least one stage configured to process waste water having a first concentration of particulate matter and/or particulate matter of a first size into a water stream having a second concentration of the particulate matter and/or particulate matter of a second size, wherein the second concentration of the particulate matter is less than the first concentration of the particulate matter and the particulate matter second size is less than the particulate matter first size; and,
at least one controller configured to analyze the second concentration of the particulate matter and/or the particulate matter second size and compare it to a predetermined particulate matter concentration and/or a predetermined particulate matter size, wherein when the second concentration of the particulate matter and/or the particulate matter second size is greater than the predetermined particulate matter concentration and/or the predetermined particulate matter size the controller causes the water stream to be recirculated through the at least one stage.

2. The water processing unit recited in claim 1, wherein the water stream exiting the water processing unit is usable water, the usable water having the predetermined particulate matter concentration and/or the predetermined particulate matter size.

3. The water processing unit recited in claim 1, wherein:
the at least one stage comprises a first stage and a second stage;
the first stage is a pre-filtration stage; and,
the second stage is an osmosis stage.

4. The water processing unit recited in claim 1, wherein:
the at least one stage comprises a first stage, a second stage, and a third stage;
the first stage is a pre-filtration stage;
the second stage is an ultra-filtration stage; and,
the third stage is an osmosis stage.

5. The water processing unit recited in claim 1, wherein:
the at least one stage comprises a first stage, a second stage, a third stage, and a fourth stage;
the first stage is a pre-filtration stage;
the second stage is an ultra-filtration stage;
the third stage is an osmosis stage; and,
the fourth stage is a disinfection stage.

6. The water processing unit recited in claim 1, wherein:
the waste water is within a temperature range from 34 degrees Fahrenheit (° F.) to 150° F.; and,
the at least one stage comprises at least one of a filter and a membrane, each configured to operate with the water stream being within the temperature range from 34° F. to 150° F.

7. The water processing unit recited in claim 5, wherein the water stream exiting the water processing unit is usable water, the usable water being within the temperature range from 34° F. to 150° F.

8. The water processing unit recited in claim 1, wherein the at least one stage is configured to operate within a differential pressure range from 50 to 70 pounds per square inch (psi).

9. The water processing unit recited in claim 8, further comprising a plurality of stages and a first stage is configured to receive the water stream from a second stage to facilitate backwashing operations.

10. The water processing unit recited in claim 1, wherein the at least one stage is configured to operate within a differential pressure range from 120 to 250 psi.

11. The water processing unit recited in claim 1, further comprising a plurality of stages, at least one stage being an osmosis stage and retentate from the osmosis stage is used for backwashing another stage.

12. The water processing unit recited in claim 5, wherein:
the pre-filtration stage comprises at least one mechanical filter;
the ultra-filtration stage comprises at least one of a micro-filter membrane, an ultra-filter membrane, and a nano-filter membrane;
the osmosis stage comprises at least one osmosis semipermeable membrane; and;
the disinfection stage comprises an application of an oxidizer agent and/or ultraviolet radiation.

13. The water processing unit recited in claim 1, further comprising a plurality of stages wherein each stage is configured to process the water stream to a purity level.

14. The water processing unit recited in claim 13, wherein the purity level of one stage differs from the purity level of another stage.

15. The water processing unit recited in claim 5, wherein:
the first stage processes the water stream to a first purity level;
the second stage processes the water stream to a second purity level;
the third stage processes the water stream to a third purity level;
the fourth stage processes the water stream to a fourth purity level; and,
the fourth purity level is greater than the third purity level, the third purity level is greater than the second purity level, and the second purity level is greater than the first purity level.

16. The water processing unit recited in claim 1, further comprising at least one energy recovery unit configured to harvest energy from the water stream.

17. The water processing unit recited in claim 16, wherein the at least one energy recovery unit comprises a battery unit, an eductor unit, and/or a pressure exchanger.

18. A water processing system, comprising:
a waste water generation source to generate waste water;
at least one first pump to direct the waste water into a water processing unit;
the water processing unit comprising at least one stage comprising a pre-filtration unit, an ultra-filtration unit, an osmosis unit, and/or a disinfection unit, the at least one stage configured to process the waste water having a first concentration of particulate matter and/or particulate matter of a first size into a water stream having a second concentration of the particulate matter and/or particulate matter of a second size, wherein the second concentration of the particulate matter is less than the first concentration of the particulate matter and the particulate matter second size is less than the particulate matter first size; and,
at least one controller configured to analyze the second concentration of the particulate matter and/or the particulate matter second size and compare it to a predetermined particulate matter concentration and/or a predetermined particulate matter size, wherein when the second concentration of the particulate matter and/or the particulate matter second size is greater than the predetermined particulate matter concentration and/or the predetermined particulate matter size the controller causes the water stream to be recirculated through the at least one stage;
the water stream exiting the water processing unit is usable water, the usable water having the predetermined particulate matter concentration and/or the predetermined particulate matter size;
at least one second pump to direct the usable water to the waste water generation source and/or outside of the water processing system.

19. A method for processing water, comprising:
receiving waste water from a waste water source into a water processing unit comprising at least one stage comprising a pre-filtration unit, an ultra-filtration unit, an osmosis unit, and/or a disinfection unit;
processing the waste water having a first concentration of particulate matter and/or particulate matter of a first size into a water stream having a second concentration of the particulate matter and/or particulate matter of a second size, wherein the second concentration of the particulate matter is less than the first concentration of the particulate matter and the particulate matter second size is less than the particulate matter first size;
analyze the second concentration of the particulate matter and/or the particulate matter second size by a controller and comparing it to a predetermined particulate matter concentration and/or a predetermined particulate matter size; and,
recirculating the water stream through the at least one stage when the second concentration of the particulate matter and/or the particulate matter second size is greater than the predetermined particulate matter concentration and/or the predetermined particulate matter size.

20. A method for processing water recited in claim 19, wherein:
the waste water is within a temperature range from 34° F. to 150° F.; and,
the water stream exiting the water processing unit is usable water, the usable water being within the temperature range from 34° F. to 150° F.
